(19) United States
(12) Patent Application Publication
(10) Pub. No.: US 2025/0315659 A1
(43) Pub. Date: Oct. 9, 2025

(54) EMBEDDING CONVOLUTIONAL NEURAL NETWORK ONTO INTEGRATED CIRCUIT DEVICE

(71) Applicants: Yaron Klein, Rosh Haayin (IL); Guy Yechezkel Azov, Petach-Tikva (IL); Yoni Elron, Hadera (IL); Yuval Vered, Tel-Aviv (IL)

(72) Inventors: Yaron Klein, Rosh Haayin (IL); Guy Yechezkel Azov, Petach-Tikva (IL); Yoni Elron, Hadera (IL); Yuval Vered, Tel-Aviv (IL)

(21) Appl. No.: 19/246,929

(22) Filed: Jun. 24, 2025

Related U.S. Application Data
(60) Provisional application No. 63/708,459, filed on Oct. 17, 2024.

(51) Int. Cl. G06N 3/0464; G06N 3/048; G06N 3/063

(52) U.S. Cl. CPC G06N 3/0464; G06N 3/048; G06N 3/063

(57) ABSTRACT

A convolutional neural network may be embedded onto an integrated circuit (IC) device, which includes an embedder unit, a flow control unit, and etched mind unit(s). The embedder unit may generate a feature map from an input image. The etched mind unit(s) may be a hardware implementation of the CNN and execute neural network operations of the CNN using the feature map. An etched mind unit may include a convolution unit implementing convolution, a batch-norm unit implementing batch normalization, an activator unit implementing an activation function operation, a max pooling unit implementing max pooling, and an average pooling unit implementing average pooling, and a MatMul unit implementing matrix multiplication, each of which may has its own memory that stores weights or other data for performing a neural network operation. The flow contour unit may orchestrate the other components of the IC device based on a timing sequence of the network.

### CROSS-REFERENCE TO RELATED APPLICATION

This application claims the benefit of U.S. Provisional Patent Application No. 63/708,459, filed Oct. 17, 2024, and titled “HARDWARE EMBEDDED MODEL FOR DEEP NEURAL NETWORK,” which is incorporated by reference in its entirety for all purposes.

### TECHNICAL FIELD

This disclosure relates generally to neural networks (also referred to as “deep neural networks” or “DNN”), and more specifically, embedding DNNs, such as convolutional neural networks (CNNs), on to integrated circuit (IC) devices.

### BACKGROUND

DNNs are used extensively for a variety of artificial intelligence applications ranging from computer vision to speech recognition and natural language processing due to their ability to achieve high accuracy. However, the high accuracy comes at the expense of significant computation cost. DNNs have extremely high computing demands as there can be a large number of operations as well as a large amount of data to read and write.

### BRIEF DESCRIPTION OF THE DRAWINGS

Embodiments can be readily understood by the following detailed description in conjunction with the accompanying drawings. To facilitate this description, like reference numerals designate like structural elements. Embodiments are illustrated by way of example, and not by way of limitation, in the figures of the accompanying drawings.

FIG. 1 illustrates exemplary data flow in a CNN, in accordance with various embodiments.

FIG. 2 illustrates an exemplary sequence of neural network operations in a CNN, in accordance with various embodiments.

FIG. 3 illustrates another exemplary sequence of neural network operations in a CNN, in accordance with various embodiments.

FIG. 4 illustrates an IC device that implements a CNN on silicon, in accordance with various embodiments.

FIG. 5 illustrates an embedder unit, in accordance with various embodiments.

FIG. 6A illustrates an exemplary convolution, in accordance with various embodiments.

FIG. 6B illustrates another exemplary convolution, in accordance with various embodiments.

FIG. 7 illustrates an exemplary workflow of a convolution unit, in accordance with various embodiments.

FIGS. 8A and 8B illustrate execution of 2D convolution by a convolution unit, in accordance with various embodiments.

FIGS. 9A-9C illustrate an activator unit, in accordance with various embodiments.

FIG. 10 illustrates a max pooling operation, in accordance with various embodiments.

FIG. 11 illustrates a workflow of a max pooling unit, in accordance with various embodiments.

FIG. 12 illustrates an average pooling operation, in accordance with various embodiments.

FIG. 13 illustrates a workflow of an average pooling unit, in accordance with various embodiments.

FIG. 14 illustrates a processing unit array, in accordance with various embodiments.

FIG. 15 illustrates sequential operations performed by a processing unit array, in accordance with various embodiments.

FIG. 16 illustrates an embedding dot unit, in accordance with various embodiments.

FIG. 17 illustrates a sequential read-only memory, in accordance with various embodiments.

FIG. 18 illustrates sequential ROMs proximate to multipliers, in accordance with various embodiments.

FIG. 19 is a block diagram of an example computing device, in accordance with various embodiments.

### DETAILED DESCRIPTION

The last decade has witnessed a rapid rise in AI based data processing, particularly based on DNNs. DNNs are widely used in the domains of computer vision, speech recognition, image, and video processing mainly due to their ability to achieve beyond human-level accuracy. A DNN typically includes a sequence of layers. A DNN layer may include one or more operations, such as matrix multiplication, convolution, interpolation, layer normalization, batch normalization, SoftMax operation, pooling, elementwise operation, linear operation, nonlinear operation, and so on. These operations are referred to as deep learning operations or neural network operations.

Neural network operations may be tensor operations. Input or output data of neural network operations may be arranged in data structures called tensors. Taking a convolutional layer for example, the input tensors include an activation tensor (also referred to as “input feature map” or “input activation tensor”) including one or more activations (also referred to as “input elements”) and a weight tensor. The weight tensor may be a kernel (a 2D weight tensor), a filter (a 3D weight tensor), or a group of filters (a 4D weight tensor). A convolution may be performed on the input activation tensor and weight tensor to compute an output activation tensor in the convolutional layer.

A tensor is a data structure having multiple elements across one or more dimensions. Examples of tensors include vector (which is one-dimensional (1D) tensor), matrix (which is two-dimensional (2D) tensor), three-dimensional (3D) tensors, four-dimensional (4D) tensors, and even higher dimensional tensors. A dimension of a tensor may correspond to an axis, e.g., an axis in a coordinate system. A dimension may be measured by the number of data points along the axis. The dimensions of a tensor may define the shape of the tensor. A DNN layer may receive one or more input tensors and compute an output tensor from the one or more input tensors. In some embodiments, a 3D tensor may have an X-dimension, a Y-dimension, and Z-dimension. The X-dimension of a tensor may be the horizontal dimension, the length of which may be the width of the tensor; the Y-dimension may be the vertical dimension, the length of which may be the height of the tensor; and the Z-dimension may be the channel dimension, the length of which may be the number of channels. The coordinates of the elements along a dimension may be integers in an inclusive range from 0 to (L-1), where L is the length of the tensor in the dimension. For instance, the x coordinate of the first element in a row may be 0, the x coordinate of the second element in a row may be 1, and so on. Similarly, the y coordinate of the first element in a column may be 0, the y coordinate of the second element in a column may be 1, and so on. A 4D tensor may have a fourth dimension, which may indicate the number of batches in the operation.

The deployment and execution of DNN models are typically carried out on general-purpose graphics processing units (GPUs), neural processing units (NPUs), and central processing units (CPUs). While GPUs, NPUs, and CPUs can provide the computational horsepower needed to handle these sophisticated models, they come with significant drawbacks, including high power consumption and latency issues. These limitations become especially problematic in environments where real-time processing and power efficiency are critical, such as in mobile devices, edge computing, and Internet of Things (IoT) applications. Many DNN models, including those based on CNNs, are deployed on GPUs or NPUs. These models, which include image recognition and other advanced applications, often face limitations related to power consumption and latency. One such model, Residual Neural Network-50 (ResNet50), is an advanced image recognition model based on CNN architecture. ResNet50 excels in image classification and object detection but suffers from the same issues when running on GPUs, NPUs, or CPUs.

Running advanced models like ResNet50 on GPUs can be slow and not power efficient due to several technical constraints. One constraint is high latency. The versatility of GPUS, NPUs, and CPUs in executing various computations introduces latency. This latency can be more pronounced in models that necessitate sequential processing, where each step relies on the completion of the previous one, as seen in image recognition tasks. This bottleneck can hinder the achievement of real-time performance, which is essential for applications like live video analysis, real-time security monitoring, interactive augmented reality (AR) systems, and so on. Another constraint is power inefficiency. GPUs, NPUs, and CPUs are known for their high power consumption. This substantial energy requirement not only limits their feasibility in battery-operated devices but also creates significant thermal management challenges. In scenarios where energy efficiency is critical, such as in portable devices, wearable technology, and remote sensing applications, the high power draw of GPUs can be a substantial disadvantage.

Some currently available solutions use dedicated accelerators that are designed specifically for AI training and inference tasks. Such accelerators can offer high performance and efficiency for specific AI workloads by optimizing hardware for the unique demands of deep learning computations. They can handle large-scale models and complex operations more effectively than general-purpose hardware. While dedicated accelerators provide unparalleled performance for AI tasks, they require frequent data movement between memory and processing units, which can introduce latency and reduce overall efficiency. This need for data transfer can limit their effectiveness for tasks that require rapid and extensive memory access.

Some other currently available solutions use AI processors. These processors can significantly outperform traditional edge AI processors in terms of area and power efficiency. Utilizing a unique, powerful, and scalable structure-driven dataflow architecture, AI processors take advantage of the core properties of neural networks. This enables edge devices to run deep learning applications at full scale more efficiently, effectively, and substantially than traditional solutions, while significantly lowering costs. Despite their impressive performance and efficiency, AI processors are often optimized for very small models and are not efficient for larger models where data needs to move back and forth from memory, impacting overall performance and efficiency. They are still not real-time.

Some other currently available solutions use a standard GPU where model weights are loaded from memory every time an inference task is being performed. While GPUs can offer flexibility, allowing them to handle a wide range of tasks, this comes at the cost of optimization, power consumption, and latency. This process can consume significant power and time, particularly for complex models. GPUs are designed to handle diverse tasks, making them inefficient for dedicated tasks like inference on a pretrained model alone.

CPUs are also used for AI inference tasks by loading the model on them. However, CPUs are not suitable for large-scale matrix multiplications, which are essential for AI inferencing tasks. They can also consume more power and can be slower in comparison to dedicated solutions. Field Programmable Gate Arrays (FPGAs) are another solution used for AI inference. They are programmable hardware that can be customized to perform specific tasks, including loading and handling model weights. While FPGAs offer flexibility, they have significantly lower performance compared to dedicated hardware solutions and are not as power-efficient and cost-effective

Embodiments of the present disclosure may improve on at least some of the challenges and issues described above by embedding DNNs onto hardware devices, such as IC devices. The model architecture and weights of a CNN may be embedded onto an IC device, such as a silicon chip. For instance, the model architecture of the CNN may be embedded onto various compute units of the IC device, and internal parameters (e.g., weights, batch normalization parameters, etc.) may be stored (etched) in memories of the IC device. An example of the CNN is the ResNet50 model, which may be used for image recognition.

In various embodiments of the present disclosure, an IC device implementing a CNN may include an embedder unit, a flow control unit, and one or more etched mind units. The embedder unit may generate a feature map from an input image. The input image may be converted to one or more tokens, which may be provided to the embedder unit. The embedder unit may convert the one or more tokens into a feature map. The one or more etched mind units may be a hardware implementation of the CNN and execute neural network operations of the CNN using the feature map. An etched mind unit may include a convolution unit, batch-norm unit, activator unit, max pooling unit, average pooling unit, and a MatMul unit. The convolution unit may be a hardware implementation of convolution, such as 2D convolution. The convolution unit may include or be coupled with one or more memories (e.g., read-only memories (ROMs) or dynamic random-access memories (DRAMs)) that store the kernel of the convolution. The one or more memories may be physically proximate to one or more multipliers in the convolution unit so that data movement can be minimized. The batch-norm unit may implement batch normalization. The batch-norm unit may apply a batch normalization function to a feature map, such as a feature map generated by the convolution unit. The batch-norm unit may include or be coupled with one or more memories that store parameters of the batch normalization function. The activator unit may apply a Rectified Linear Unit (ReLU) activation function on a feature map, such as a feature map generated by the batch-norm unit or the MatMul unit. The activator unit may be a ReLU unit. The max pooling unit may implement max pooling operation to down sample a feature map, such as a feature map generated by the ReLU unit. The average pooling may implement average pooling operation to down sample a feature map, such as a feature map generated by the ReLU unit. The MatMul unit may implement matrix multiplication operation (MatMul) or addition. The MatMul may include or be coupled with one or more memories that stores weights for MatMul. One or more memories inside the IC device may be static random-access memories (SRAMs) in some implementations. The SRAMs may facilitate update of internal parameters of the CNN using the IC device, e.g., by fine-tuning the CNN.

Neural network operations in the CNN may be sequential. The flow contour unit may orchestrate the other components of the IC device based on a timing sequence of the CNN. These components of the IC device can collectively enhance processing speed, power efficiency, and overall performance in AI tasks, enabling real-time image recognition and classification applications. Some or all of the units may be implemented as a processing unit array. Each processing unit in the array may include one or more internal memories, multipliers, and adders to efficiently perform basic computations in the CNN.

Compared with currently available solutions, the approach in this disclosure has various advantages. An advantage is real-time computing. The power efficiency and performance boost offered by this approach can make it ideal for edge computing, mobile, and loT applications where resources are limited and low latency is required. Real-time image recognition and processing capabilities can be feasible, enabling use cases such as live video analytics, autonomous navigation, real-time object detection, and interactive AR systems. The ability to process images in real-time opens up new possibilities for user interaction and automation.

Another advantage of the approach in this disclosure is performance boost. By hardcoding the ResNet50 model's weights and architecture onto the chip, the time and power required to load these weights from memory are eliminated. This direct integration of model parameters into the silicon removes the need for data transfer between memory and processing units. Consequently, inference tasks can be executed faster, providing a significant performance boost. Additionally, the optimized convolutional layers and pooling operations ensure rapid and efficient processing of data, further enhancing performance. This is particularly beneficial for real-time image recognition and classification applications where low latency is crucial.

Another advantage of the approach in this disclosure is power efficiency. The approach in the present disclosure can reduce power consumption by eliminating the need to repeatedly load weights and models from memory for each inference task. By embedding the ResNet50 model directly onto the chip, it can eliminate the need for memory access operations. The use of specialized hardware modules, such as sequential read memory (which powers on the needed next line) and Look-Up Table based activation functions, contributes to lower power usage for edge devices, where power efficiency is paramount. This reduction in power consumption may be crucial. This can make the solution more power-efficient, reducing overall operational cost and making it a more environmentally friendly solution.

Another advantage of the approach in this disclosure is cost-effective. Unlike general-purpose GPUs or NPUs, these dedicated chips are specifically designed to handle AI inference tasks. They usually do not carry any overhead of unnecessary or general-purpose functionalities, making the solution more cost-effective. The tailored design for image recognition and classification applications ensures that resources are utilized efficiently, providing a cost advantage over more generalized hardware solutions.

Another advantage of the approach in this disclosure is scalability. Due to the encapsulation of specialized ResNet50 models on multiple chips and the use of an efficient interface, the system may require very low bandwidth per inference task into the System on Chip (SoC). Multiple SoCs can be connected in parallel to simultaneously handle numerous batches of inference requests with low overhead, enhancing scalability. This makes the solution adaptable for various scales of deployment, from small devices to large-scale server environments.

Another advantage of the approach in this disclosure is security. As the models and weights are hardcoded into the hardware, model integrity can be assured and less susceptible to manipulation, enhancing security. This can be particularly important for applications requiring secure and reliable real-time image processing, such as in surveillance, healthcare, and other sensitive industries.

This approach offers an optimal way to utilize CNNs (e.g., ResNet50 models) by leveraging hardware-optimized inferencing. By embedding the ResNet50 model directly onto silicon, the solution can overcome current limitations, offering real-time processing that is not available with existing software-based implementations. This enhancement in real-time capability ensures that users can benefit from immediate and accurate image recognition and classification, opening new possibilities in various real-time applications. This hardware optimization can not only reduce power consumption but also significantly lower latency, making it ideal for applications requiring immediate response times.

This approach can be advantageous in real-time use cases such as autonomous driving, security surveillance, medical image analysis, and interactive visual systems. This approach ensures that the model operates efficiently, providing real-time performance without the drawbacks associated with GPU-based execution. By embedding ResNet50 on silicon, a seamless integration of image recognition capabilities into a wide range of devices, from mobile phones to edge computing systems, can be achieved ultimately enhancing user experience and expanding the potential applications of image recognition technology.

For purposes of explanation, specific numbers, materials and configurations are set forth in order to provide a thorough understanding of the illustrative implementations. However, it can be apparent to one skilled in the art that the present disclosure may be practiced without the specific details or/and that the present disclosure may be practiced with only some of the described aspects. In other instances, well known features are omitted or simplified in order not to obscure the illustrative implementations.

Further, references are made to the accompanying drawings that form a part hereof, and in which is shown, by way of illustration, embodiments that may be practiced. It is to be understood that other embodiments may be utilized, and structural or logical changes may be made without departing from the scope of the present disclosure. Therefore, the following detailed description is not to be taken in a limiting sense.

Various operations may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order from the described embodiment. Various additional operations may be performed or described operations may be omitted in additional embodiments.

For the purposes of the present disclosure, the phrase “A or B” or the phrase “A and/or B” means (A), (B), or (A and B). For the purposes of the present disclosure, the phrase “A, B, or C” or the phrase “A, B, and/or C” means (A), (B), (C), (A and B), (A and C), (B and C), or (A, B, and C). The term “between,” when used with reference to measurement ranges, is inclusive of the ends of the measurement ranges.

The description uses the phrases “in an embodiment” or “in embodiments,” which may each refer to one or more of the same or different embodiments. The terms “comprising,” “including,” “having,” and the like, as used with respect to embodiments of the present disclosure, are synonymous. The disclosure may use perspective-based descriptions such as “above,” “below,” “top,” “bottom,” and “side” to explain various features of the drawings, but these terms are simply for ease of discussion, and do not imply a desired or required orientation. The accompanying drawings are not necessarily drawn to scale. Unless otherwise specified, the use of the ordinal adjectives “first,” “second,” and “third,” etc., to describe a common object, merely indicates that different instances of like objects are being referred to and are not intended to imply that the objects so described must be in a given sequence, either temporally, spatially, in ranking or in any other manner.

In the following detailed description, various aspects of the illustrative implementations are described using terms commonly employed by those skilled in the art to convey the substance of their work to others skilled in the art.

The terms “substantially,” “close,” “approximately,” “near,” and “about,” generally refer to being within +/−20% of a target value as described herein or as known in the art. Similarly, terms indicating orientation of various elements, e.g., “coplanar,” “perpendicular,” “orthogonal,” “parallel,” or any other angle between the elements, generally refer to being within +/−5-20% of a target value as described herein or as known in the art.

In addition, the terms “comprise,” “comprising,” “include,” “including,” “have,” “having” or any other variation thereof, are intended to cover a non-exclusive inclusion. For example, a method, process, device, or DNN accelerator that comprises a list of elements is not necessarily limited to only those elements but may include other elements not expressly listed or inherent to such method, process, device, or DNN accelerators. Also, the term “or” refers to an inclusive “or” and not to an exclusive “or.”

The systems, methods and devices of this disclosure each have several innovative aspects, no single one of which is solely responsible for all desirable attributes disclosed herein. Details of one or more implementations of the subject matter described in this specification are set forth in the description below and the accompanying drawings.

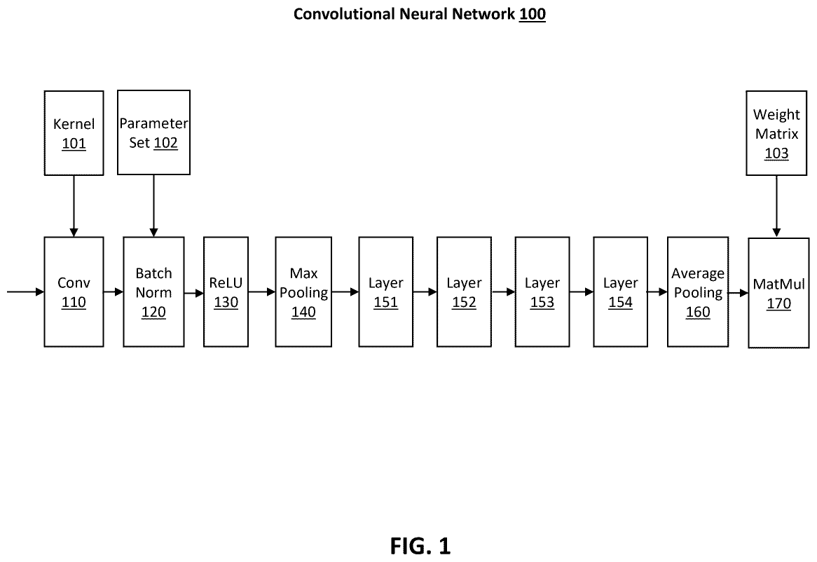

FIG. 1 illustrates exemplary data flow in a CNN 100, in accordance with various embodiments. The CNN 100 may have been trained to handle one or more AI tasks, such as image recognition, image classification, other types of image processing tasks, or some combination thereof. In some embodiments, the CNN 100 may receive tokens converted from one or more images as input and may output labels indicating recognition or classification of objects in images(s). An example of the CNN 100 is the ResNet50 model. The CNN 100 may be trained using residual learning mechanism, with which the CNN 100 can learn residual functions with reference to the layer inputs, improving training efficiency and accuracy by addressing the vanishing gradient problem.

The CNN 100 includes a sequence of layers, such as convolutional layers, pooling layers, fully connected layers, and so on. In an example, the CNN 100 may have 50 layers. A layer may include one or more neural network operations, such as convolution, activation function, pooling, matrix multiplication operation (MatMul), linear operation, elementwise operation, and so on. An inference process of the CNN 100 may start with an input image that undergoes transformation through various layers in the CNN 100. As shown in FIG. 1, the CNN 100 includes a convolution 110 (shown as “2D conv” in FIG. 1), batch normalization 120, ReLU activation function 130, max pooling 140, layer 151, layer 152, layer 153, layer 154, average pooling 160, and a MatMul 170. In other embodiments, the CNN 100 may include fewer, more, or different neural network operations. Further, the order of the neural network operations may be different from the order shown in FIG. 1.

The convolution 110 may be a convolution having a kernel 101. In some embodiments, the convolution 110 is a 2D convolution. The kernel 101 may be a 2D tensor. In some embodiments, the height and width of the kernel 101 may be the same and may be referred to as KERNEL_SIZE. In an example of KERNEL_SIZE being 7, the spatial shape or size of the kernel 101 may be denoted as 7×7 or (7,7). The kernel 101 may be applied on an input feature map, which may be converted from the input image, e.g., by converting the input image to tokens and further converting the tokens to embedding vectors. The input feature map, which is also referred to as an input tensor or input activation tensor, may be a tensor of activations. The input feature map may be a 2D tensor or 3D tensor. In embodiments where the input feature map is a 3D tensor, the depth of the tensor may indicate the number of channels. The kernel 101 may be applied on the 2D tensor for each channel.

During the convolution 110, the kernel 101 may slide over the input feature map both down and to the right. In some embodiments, the kernel 101 may slide one element (e.g., one row for sliding down, or one column for sliding to the right) at a time. In other embodiments, the kernel 101 may slide multiple elements (e.g., multiple rows for sliding down, or multiple columns for sliding to the right) at a time. The numbers of rows or columns traversed per slide is referred to as stride. In an example, the stride of the convolution 110 may be (2, 2) or 2, which indicates the kernel 101 slides two rows down and slides two columns to the right.

In some embodiments, the input feature map may be padded before the kernel 101 is applied on the input feature map. Padding is a process of adding new elements to the input feature map. For instance, zeros may be added to the input feature map. The new elements may be added to one or more edges of the input feature map. The convolution 110 may have one or more padding parameters, which indicates how many rows or columns are added to the input feature map. In an example, the padding of the convolution 110 may be (3, 3) or 3, which indicates that 3 rows of zeros are added to the top and the bottom of the input feature map and 3 columns of zeros are added to the left and the right of the input feature map. The padded tensor has a larger size than the original input feature map.

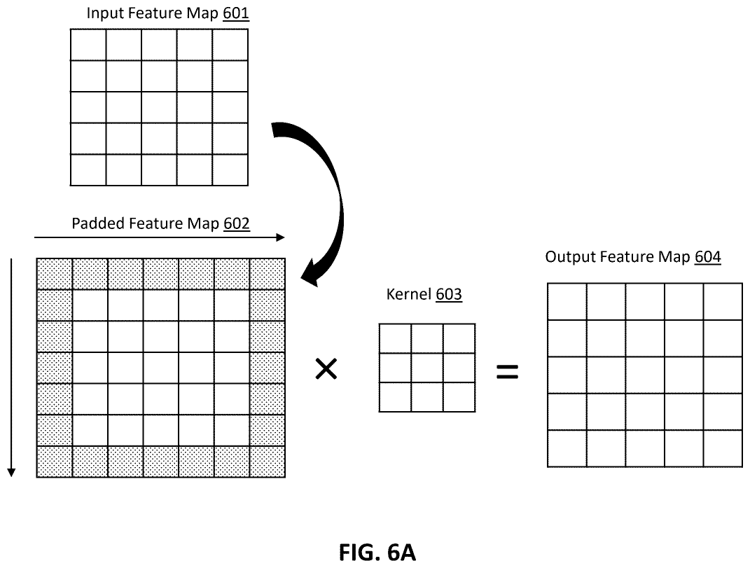

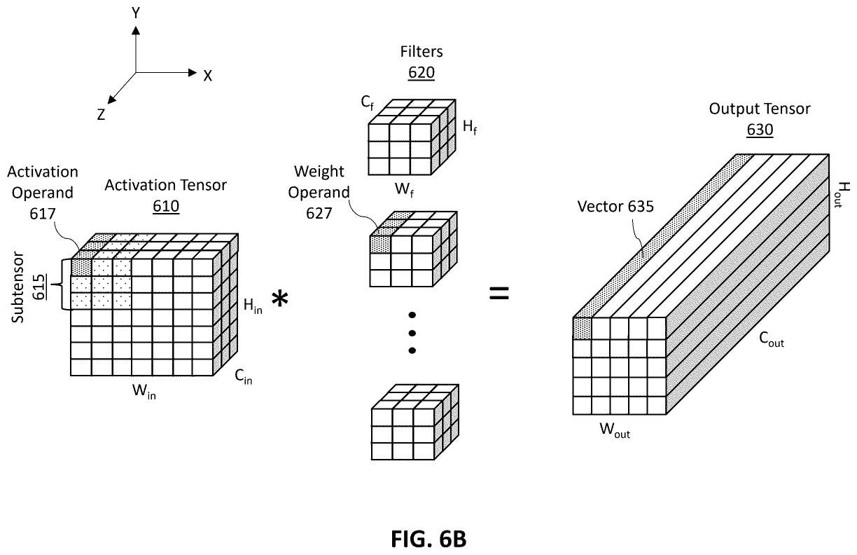

The convolution 110 may produce an output feature map, which may be referred to as an output tensor or output activation tensor. The output activation tensor is further process in subsequent layers of the CNN 100. In an example, the spatial size of the input feature map is denoted as (3, 224, 224), indicating that there are 3 input channels and each input channel is a 224×224 2D tensor. Also, the KERNEL_SIZE is 7, indicating that the spatial size of the kernel is (7, 7). The padding is (3, 3) and stride is (7, 7). The kernels for all the three input channels may constitute a 3D weight tensor (3, 7, 7). In this example, there may be 64 weight tensors to produce a (64, 112, 112) output feature map, indicating that there are 64 output channels and each output channel is a 112×112 2D tensor. Certain aspects of convolution are described below in conjunction with FIGS. 6A and 6B.

The batch normalization 120 may normalize inputs to layers in the CNN 100 using the batch normalization technique. Batch normalization can improve the training of the CNN 100 by normalizing the inputs to each layer. In some embodiments, batch normalization may be applied after each convolutional layer and before the activation function. This can help stabilize and accelerate the training process by reducing internal covariate shift, ensuring that the distribution of inputs to each layer remains consistent. The batch normalization 120 may include applying a batch normalization function on inputs. The batch normalization function may be denoted as:

$$y = \frac{x - E [ x ]}{\sqrt{Var ( x ) + ∈}} γ + β ,$$

where E[x] the mean, Var(x) is the variance, ∈ is a constant, γ is the scale, and β is the shift. The batch normalization 120 may receive a parameter set 102, which may include the scale and shift. In an example, the batch normalization 120 may apply the batch normalization function on the output feature map of the convolution 110 and output a new tensor. In the example where the output feature map of the convolution 110 has a spatial size (64, 112, 112), the output of the batch normalization 120 may be a tensor having a spatial size (64, 112, 112).

The ReLU activation function 130 may apply ReLU on the tensor from the batch normalization 120. ReLU may be denoted as: f(x)=max (0,x), where x is the input. The ReLU activation function 130 may output its input direct when the input is positive. Otherwise, the ReLU activation function 130 may output zero. The ReLU activation function 130 may increase sparsity in the feature map. In the example where the tensor from the batch normalization 120 has a spatial size (64, 112, 112), the output of the ReLU activation function 130 may be a tensor having a spatial size (64, 112, 112).

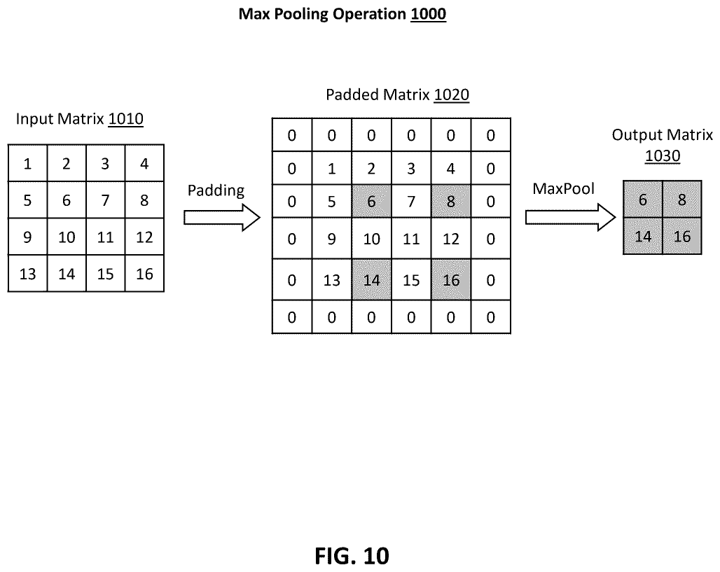

The max pooling 140 is a pooling operation for reducing spatial dimensions of feature maps. The max pooling 140 may extract windows from its input tensor, e.g., the tensor from the ReLU activation function 130. A window is a defined region within the input tensor. The max pooling 140 may find the largest value in each window and outputs the largest values of the windows as a new feature map. In the example where the tensor from the batch normalization 120 has a spatial size (64, 112, 112), the output of the ReLU activation function 130 may be a tensor having a spatial size (64, 56, 56). The max pooling 140 can effectively down samples the input and reduce the number of computations while adding a degree of translation invariance to the CNN 100. Certain aspects regarding max pooling are described below in conjunction with FIG. 10.

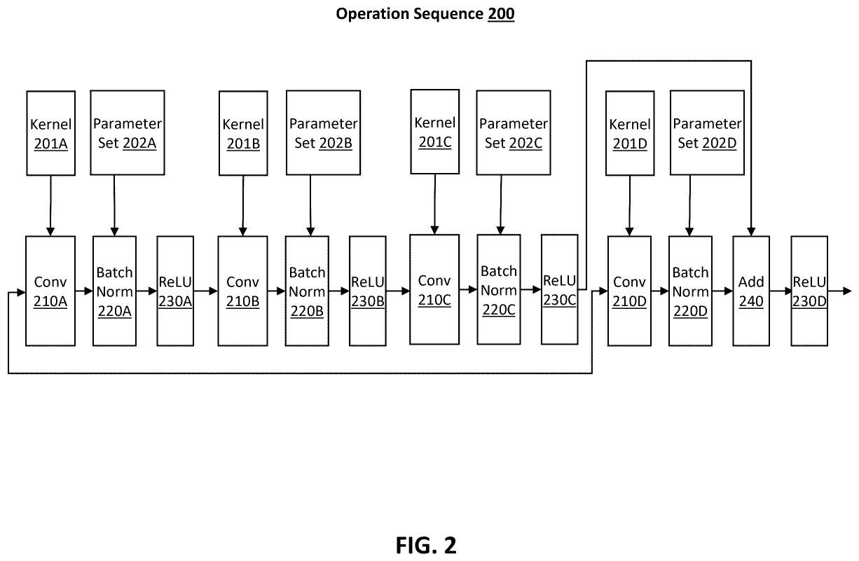

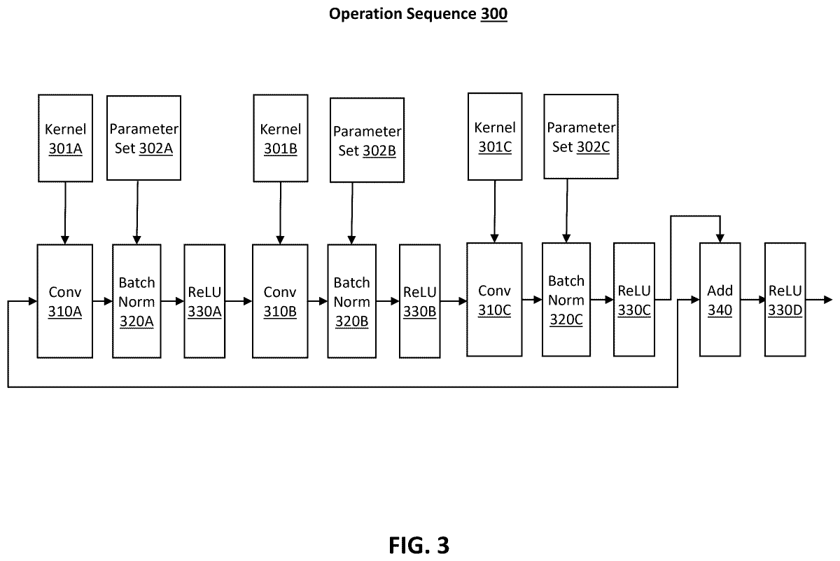

The output of the max pooling 140 is an input to the layer 151 and is sequentially processed through the layers 151-154. Each of the layers 151-154 may have a sequence of neural network operations, which may include convolution, batch normalization, ReLU, and so on. The output of a layer is the input of the next layer. As the feature map goes through the layers 151-154, the number of channels may increase while the height or width of the feature map may decrease. In an example, the layer 151 has a (64, 56, 56) input feature map and a (256, 56, 56) output feature map. The layer 152 has a (512, 28, 28) output feature map. The layer 153 has a (1024, 14, 14) output feature map. The layer 154 has a (2048, 7, 7) output feature map. Certain aspects regarding these layers are described below in conjunction with FIG. 2 and FIG. 3.

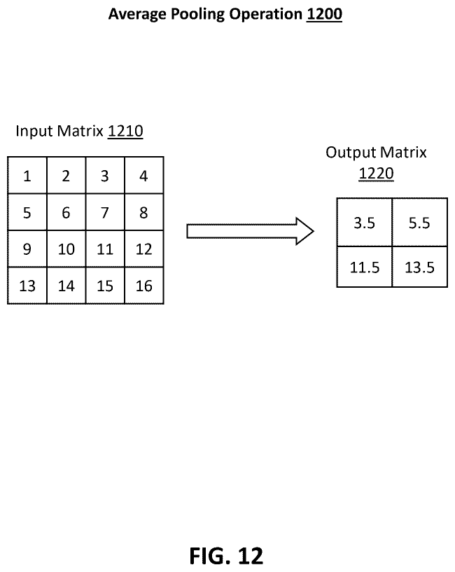

The average pooling 160 is another pooling operation for reducing spatial dimensions of feature maps. The average pooling 160 may extract windows from its input tensor, e.g., the tensor from the ReLU activation function 130. A window is a defined region within the input tensor. The average pooling 160 may compute the average of the values in each window and outputs the average values of the windows as a new feature map. The average pooling 160 can effectively down samples the input, reducing computational complexity and aiding in the extraction of the most significant features. In an example, the average pooling 160 may receive a (2048, 7, 7) feature map and convert the feature map to a (2048) vector. Certain aspects regarding average pooling are described below in conjunction with FIG. 12.

The MatMul 170 may be applied on the output of the average pooling 160 and a weight matrix 103. The weight matrix 103 may be denoted as W_{cls}. During the MatMul 170, a dot product may be performed between each row of the input (e.g., the feature map from the average pooling 160) and each column of the weight matrix 103 to generate a single point in the output. In an example, the feature map from the 160 is a (2048) vector, the weight matrix 103 is a (2048,1000) matrix, and the output of the MatMul 170 is a (1000) vector. The MatMul 170 may produce a classification output. The classification output may represent a prediction of the CNN 100 made using the input image. In some embodiments, the prediction may be a classification of one or more objects in the input image.

FIG. 2 illustrates an exemplary sequence of neural network operations in a CNN, in accordance with various embodiments. The sequence of neural network operations is referred to as an operation sequence 200. The CNN may be an example of the CNN 100. The operation sequence 200 may be at least part of a layer, such as the layer 151, 152, 153, or 154.

As shown in FIG. 2, the operation sequence 200 includes a convolution 210A, batch normalization 220A, ReLU 230A, convolution 210B, batch normalization 220B, ReLU 230B, convolution 210C, batch normalization 220C, ReLU 230C, convolution 210D, batch normalization 220D, addition 240 (shown as “add” in FIG. 2), and ReLU 230D. The four convolutions 210A-210D may be collectively referred to as “convolutions 210” or “convolution 210.” In some embodiments, the convolutions 210 may be 2D convolutions. The four batch normalizations 220A-220D may be collectively referred to as “batch normalizations 220” or “batch normalization 220.” The batch normalizations 220 may have the same batch normalization function as the batch normalization 120 in FIG. 1. The four ReLUs 230A-230D may be collectively referred to as “ReLUs 230” or “ReLU 230.” The ReLUs 230 may have the same ReLU activation function as the ReLU activation function 130 in FIG. 1.

The convolution 210A has a kernel 201A. In some embodiments, the input feature map of the convolution 210A may be the output of the max pooling 140 in FIG. 1. In other embodiments, the input feature map of the convolution 210A may be the output feature map of a layer, such as the layer 151, 152, or 153. In an example, the convolution 210A has a (1,1) kernel. The kernel may be a part of a (64, 64, 1,1) weight tensor, in which the first number indicates the number of output channels of the convolution 210A and the second number indicates the number of input channels of the convolution 210A. The weight tensor may be denoted as W_{conv1}. The convolution 210A may also have a (64, 56, 56) input feature map and a (1,1) stride in this example. The output feature map of the convolution 210A in this example may have the same spatial shape and size as the input feature map.

The batch normalization 220A may be performed on the output feature map of the convolution 210A using a parameter set 202A. The parameter set 202A may be denoted as BN₁. The output of the batch normalization 220A may be a (64, 56, 56) tensor in the example described above. The ReLU 230A applies the ReLU activation function on the output of the batch normalization 220A and produces a (64, 56, 56) tensor.

The convolution 210B has a kernel 201B. In some embodiments, the input feature map of the convolution 210B may be the output of the ReLU 230A. In an example, the convolution 210B has a (3,3) kernel. The kernel may be a part of a (64, 64, 3,3) weight tensor, in which the first number indicates the number of output channels of the convolution 210B and the second number indicates the number of input channels of the convolution 210B. The weight tensor may be denoted as W_{conv2}. When the input feature map is a (64, 56, 56) tensor and the convolution 210B has a (1,1) stride and a (1,1) padding, the output feature map of the convolution 210B may be a (64, 56, 56) tensor.

The batch normalization 220B may be performed on the output feature map of the convolution 210B using a parameter set 202B. The parameter set 202B may be denoted as BN₂. The output of the batch normalization 220B may be a (64, 56, 56) tensor in the example described above. The ReLU 230B applies the ReLU activation function on the output of the batch normalization 220B and produces a (64, 56, 56) tensor.

The convolution 210C receives the output feature map of the ReLU 230B. The convolution 210C has a kernel 201C. In an example, the convolution 210C has a (1,1) kernel. The kernel may be a part of a (256, 64, 1,1) weight tensor, indicating that the convolution 210C has 256 output channels and 64 input channels. The weight tensor may be denoted as W_{conv3}. When the input feature map is a (64, 56, 56) tensor and the convolution 210C has a (1,1) stride and a (1,1) padding, the output feature map of the convolution 210C may be a (256, 56, 56) tensor.

The batch normalization 220C may be performed on the output feature map of the convolution 210C using a parameter set 202C. The parameter set 202C may be denoted as BN₃. The output of the batch normalization 220C may be a (256, 56, 56) tensor in the example described above. The ReLU 230C applies the ReLU activation function on the output of the batch normalization 220C and produces a (256, 56, 56) tensor.

The convolution 210D has the same input feature map as the convolution 210A. The convolution 210D has a kernel 201D. In an example, the convolution 210D has a (1,1) kernel. The kernel may be a part of a (256, 64, 1,1) weight tensor, indicating that the convolution 210D has 256 output channels and 64 input channels. The weight tensor may be denoted as W_{conv_down}. When the input feature map is a (64, 56, 56) tensor and the convolution 210D has a (1,1) stride and a (1,1) padding, the output feature map of the convolution 210D may be a (256, 56, 56) tensor.

The batch normalization 220D may be performed on the output feature map of the convolution 210D using a parameter set 202D. The parameter set 202D may be denoted as BN down. The output of the batch normalization 220D may be a (256, 56, 56) tensor in the example described above. The addition 240 may perform an elementwise addition on the output of the batch normalization 220D and the output of the ReLU 230C. In an example, the output of the batch normalization 220D is a (256, 56, 56) tensor and the output of the ReLU 230C is also a (256, 56, 56) tensor. The addition 240 may produce a (256, 56, 56) tensor. Each element in the output tensor of the addition 240 may be the sum of a corresponding element in the output tensor of the batch normalization 220D and a corresponding element in the output tensor of the ReLU 230C. The ReLU 230D applies the ReLU activation function on the output of the addition 240 and produces a (256, 56, 56) tensor. The output of the ReLU 230D may be further processed in the rest of the CNN.

FIG. 3 illustrates another exemplary sequence of neural network operations in a CNN, in accordance with various embodiments. The sequence of neural network operations is referred to as an operation sequence 300. The CNN may be an example of the CNN 100. The sequence of neural network operations may be at least part of a layer, such as the layer 151, 152, 153, or 154.

As shown in FIG. 3, the operation sequence 300 includes a convolution 310A, batch normalization 320A, ReLU 330A, convolution 310B, batch normalization 320B, ReLU 330B, convolution 310C, batch normalization 320C, ReLU 330C, addition 340 (shown as “add” in FIG. 3), and ReLU 330D. The three convolutions 310A-310C may be collectively referred to as “convolutions 310” or “convolution 310.” In some embodiments, the convolutions 310 may be 3D convolutions. The three batch normalizations 320A-320C may be collectively referred to as “batch normalizations 320” or “batch normalization 320.” The batch normalizations 320 may have the same batch normalization function as the batch normalization 120 in FIG. 1. The four ReLUs 330A-330D may be collectively referred to as “ReLUs 330” or “ReLU 330.” The ReLUs 330 may have the same ReLU activation function as the ReLU activation function 130 in FIG. 1.

The convolution 310A has a kernel 301A. In some embodiments, the input feature map of the convolution 310A may be the output of an instance of the operation sequence 200 or another instance of the operation sequence 300. In an example, the convolution 310A has a (1,1) kernel. The kernel may be a part of a (64, 256, 1, 1) weight tensor, indicating that the convolution 310A has 64 output channels and 256 input channels. The weight tensor may be denoted as W_{conv1}. The convolution 310A may also have a (256, 56, 56) input feature map and a (1,1) stride in this example. The output feature map of the convolution 310A in this example may be a (64, 56, 56) tensor.

The batch normalization 320A may be performed on the output feature map of the convolution 310A using a parameter set 302A. The parameter set 302A may be denoted as BN₁. The output of the batch normalization 320A may be a (64, 56, 56) tensor in the example described above. The ReLU 330A applies the ReLU activation function on the output of the batch normalization 320A and produces a (64, 56, 56) tensor.

The convolution 310B has a kernel 301B. In some embodiments, the input feature map of the convolution 310B may be the output of the ReLU 330A. In an example, the convolution 310B has a (3,3) kernel. The kernel may be a part of a (64, 64, 3,3) weight tensor, in which the first number indicates the number of output channels of the convolution 310B and the second number indicates the number of input channels of the convolution 310B. The weight tensor may be denoted as W_{conv2}. When the input feature map is a (64, 56, 56) tensor and the convolution 310B has a (1,1) stride and a (1,1) padding, the output feature map of the convolution 310B may be a (64, 56, 56) tensor.

The batch normalization 320B may be performed on the output feature map of the convolution 310B using a parameter set 302B. The parameter set 302B may be denoted as BN₂. The output of the batch normalization 320B may be a (64, 56, 56) tensor in the example described above. The ReLU 330B applies the ReLU activation function on the output of the batch normalization 320B and produces a (64, 56, 56) tensor.

The convolution 310C receives the output feature map of the ReLU 330B. The convolution 310C has a kernel 301C. In an example, the convolution 310C has a (1,1) kernel. The kernel may be a part of a (256, 64, 1, 1) weight tensor, indicating that the convolution 310C has 356 output channels and 64 input channels. The weight tensor may be denoted as W_{conv3}. When the input feature map is a (64, 56, 56) tensor and the convolution 310C has a (1,1) stride and a (1,1) padding, the output feature map of the convolution 310C may be a (256, 56, 56) tensor.

The batch normalization 320C may be performed on the output feature map of the convolution 310C using a parameter set 302C. The parameter set 302C may be denoted as BN₃. The output of the batch normalization 320C may be a (256, 56, 56) tensor in the example described above. The ReLU 330C applies the ReLU activation function on the output of the batch normalization 320C and produces a (256, 56, 56) tensor.

The addition 340 may perform an elementwise addition on the output of the ReLU 330C and the input feature map of the convolution 310A. In an example, the output of the ReLU 330C is a (256, 56, 56) tensor, and the input feature map of the convolution 310A is also a (256, 56, 56) tensor. The addition 340 may produce a (256, 56, 56) tensor. Each element in the output tensor of the addition 340 may be the sum of a corresponding element in the input feature map of the convolution 310A and a corresponding element in the output tensor of the ReLU 330C. The ReLU 330D applies the ReLU activation function on the output of the addition 340 and produces a (256, 56, 56) tensor. The output of the ReLU 330D may be further processed in the rest of the CNN.

In some embodiments, the layer 151, 152, 153, or 154 may include one or more instances of the operation sequence 200 and one or more instances of the operation sequence 300. For example, the layer 151 may include an instance of the operation sequence 200, followed by an instance of the operation sequence 300, further followed by another instance of the operation sequence 300. The layer 152 may include an instance of the operation sequence 200, followed by three instances of the operation sequence 300. The layer 153 may include an instance of the operation sequence 200, followed by five instances of the operation sequence 300. The layer 154 may include an instance of the operation sequence 200, followed by two instances of the operation sequence 300.

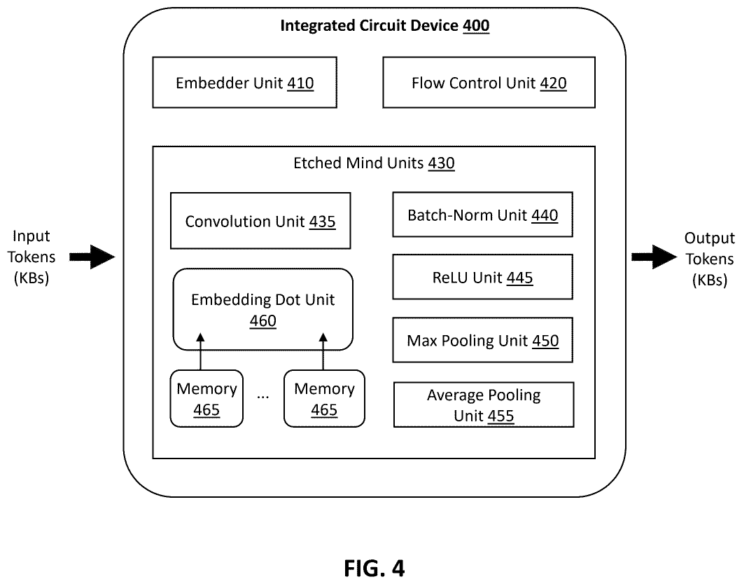

FIG. 4 illustrates an IC device 400 that that implements a CNN on silicon, in accordance with various embodiments. The model architecture, internal parameters (e.g., weights), and flow of the CNN can be embedded onto the IC device 400. An example of the CNN is the CNN 100 in FIG. 1. The IC device 400 may be a chip, such as a silicon chip. In some embodiments, the IC device 400 receives tokens in and outputs tokens out. An input token may be converted from an input image. An output token may be a prediction of the CNN.

As shown in FIG. 4, the IC device 400 includes an embedder unit 410, flow control unit 420, and etched mind unit 430. The etched mind unit 430 includes a convolution unit 435, batch-norm unit 440, ReLU unit 445, max pooling unit 450, average pooling unit 455, embedding dot unit 460, and memories 465. A unit in the IC device 400 may be a circuit or may include multiple circuits. In other embodiments, the IC device 400 may include fewer, more, or different components. For instance, the IC device 400 may include more than one embedder unit 410, flow control unit 420, etched mind unit 430, convolution unit 435, batch-norm unit 440, ReLU unit 445, max pooling unit 450, average pooling unit 455, or embedding dot unit 460. Further, functionality attributed to a component of IC device 400 may be accomplished by a different component included in the IC device 400 or a different device.

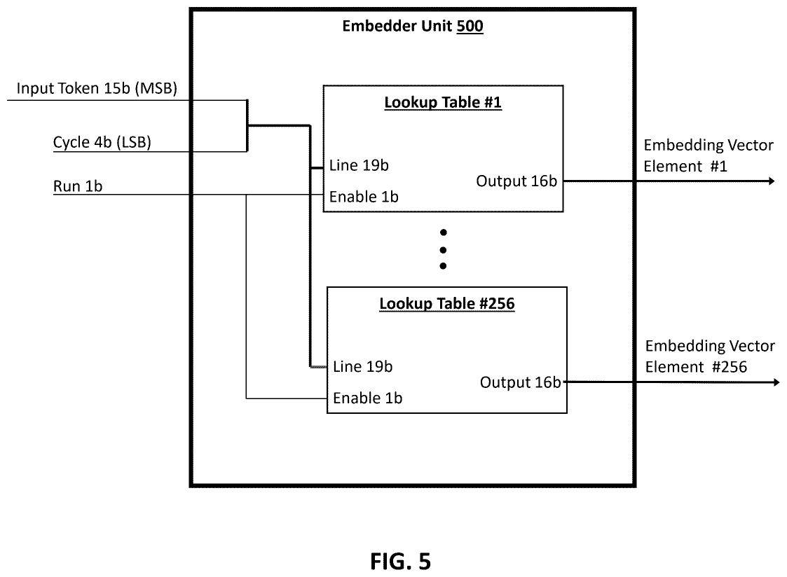

The embedder unit 410 may be hardware implementation of an embedder included in or associated with the CNN. In embodiments where the embedder is included in the CNN, the embedder may be an embedding layer. The embedder unit 410 may execute the embedder to convert input tokens to embedding tensors (e.g., embedding vectors). In some embodiments, the embedder unit 410 may include look-up tables that map tokens to embedding elements. The look-up tables may output embedding elements corresponding to the input tokens. The embedding elements may constitute the embedding tensor of the input tokens. Certain aspects of the embedder unit 410 are described below in conjunction with FIG. 5.

The flow control unit 420 plays a role in orchestrating various circuits to execute operations according to a predetermined timing sequence. The flow control unit 420 may also be referred to as a sequencer unit, which can orchestrate one or more other components of the IC device 400 according to a predetermined timing sequence of the speech recognition model. The speech recognition model may operate in a feedforward manner. The sequence of operations of the model corresponding to different layers of the neural network can be determined and mapped into a timing sequence of neural network operations, including convolution, batch normalization, ReLU activation function, max pooling, average pooling, elementwise addition, MatMul, and so on. In some embodiments, the timing sequence of neural network operations in the CNN may follow the sequence shown in FIG. 1, FIG. 2, or FIG. 3. The timing sequence of neural network operations may include stages of operations, one following another. In a particular time slot or stage in the timing sequence, data can be moved in, processed, and moved out to be processed in the next/following time slot, in a feedforward, progressive manner. The flow control unit 420 may implement digital logic to generate clock edges/signals (e.g., control signals, timing signals, enable signals, disable signals, trigger signals, etc.) to orchestrate operations to be performed according to the timing sequence. The flow control unit 420 may control data flow into or out of one or more other components of the IC device 400. The flow control unit 420 may also enable or disable one or more other components of the IC device 400 according to a predetermined timing sequence.

The etched mind unit 430 is a hardware implementation of neural network operations in the CNN. For example, the model architecture of the CNN may be embedded (mapped) onto the compute components of the etched mind unit 430, such as the convolution unit 435, batch-norm unit 440, ReLU unit 445, max pooling unit 450, average pooling unit 455, and embedding dot unit 460. The internal parameters of the CNN may be etched (stored) in the memories 465 or other memories not shown in FIG. 4 (e.g., memories coupled with or included in the compute components of the etched mind unit 430).

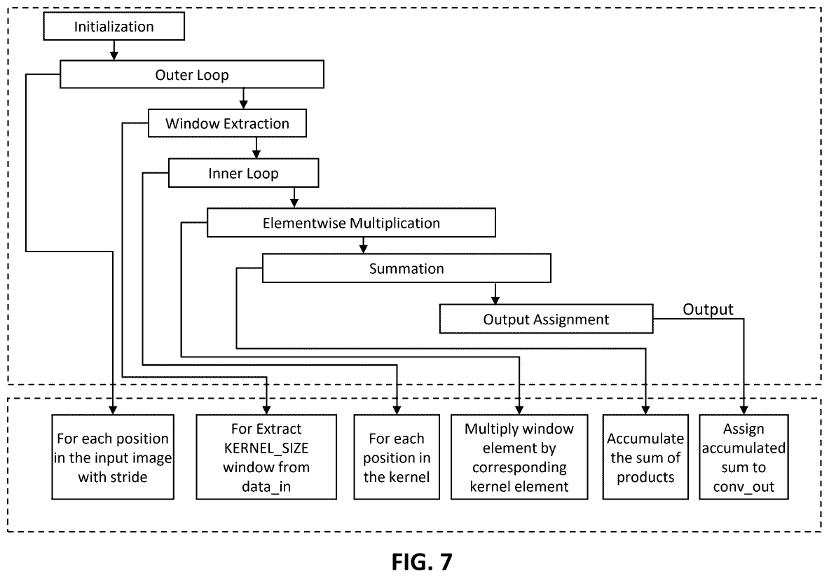

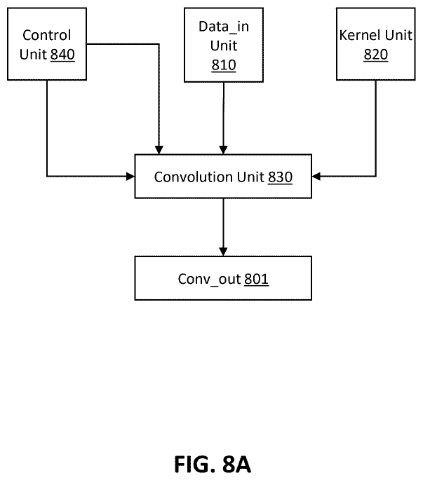

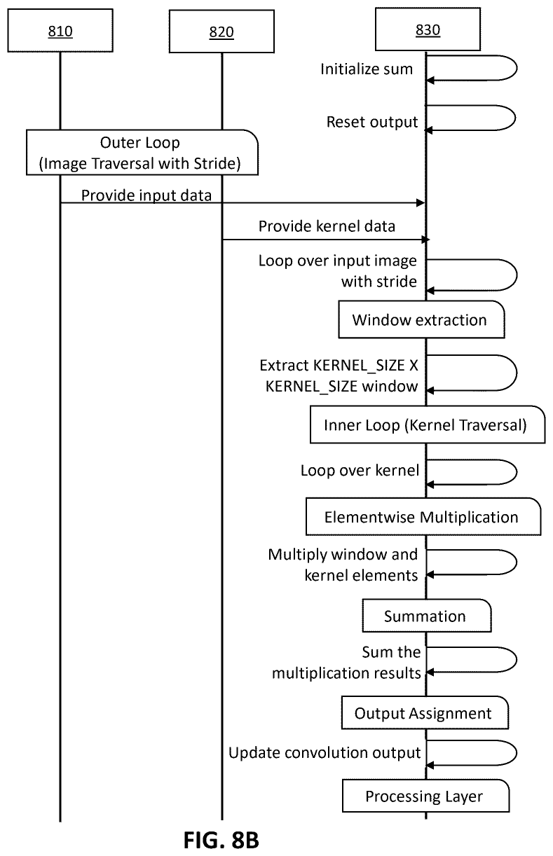

The convolution unit 435 implements convolutions (e.g., 2D convolutions) in the CNN. Examples of convolutions embedded on to the convolution unit 435 include the convolution 110 in FIG. 1, the convolutions 210 in FIG. 2, and the convolutions 310 in FIG. 3. The convolution unit 435 may include one or more multipliers and one or more adders for performing multiply-accumulate (MAC) operations in convolution. The convolution unit 435 may be coupled with or include one or more data storage units that store convolutional weights. The one or more data storage units may be proximate to the one or more multipliers so that data movement can be minimized to improve efficiency. In some embodiments, a data storage unit may be a DRAM or ROM (e.g., a sequential read-only memory). In other embodiments, a data storage unit may be a SRAM, which can facilitate update of the convolutional weights by fine-tuning at least part of the CNN. CNN fine-tuning may be a process of further training or retraining a pre-trained CNN to further modify one or more internal parameters (e.g., weights) of the CNN. The CNN may be fine-tuned using a dataset including fine-tuning samples (e.g., images) and ground-truth labels of the samples (e.g., ground-truth recognition or classification of the images). One or more internal parameters of the CNN may be updated to minimize a loss of the CNN, which may be measured by the difference between the CNN's prediction made based on the fine-tuning samples and the ground-truth labels. The fining-tuning may be a low rank adaption (LoRA) fine-tuning, which may provide 2% update. In some embodiments, the convolution unit 435 may include one or more processing units. Each processing unit may have one or more data storage units, one or more multipliers, and one or more adders. The processing units may be arranged in an array. Certain aspects of convolution unit are described below in conjunction with FIG. 7 and FIGS. 8A and 8B.

The batch-norm unit 440 is a hardware implementation of one or more batch normalizations in the CNN, such as the batch normalization 120 in FIG. 1, batch normalizations 220 in FIG. 2, and batch normalizations 320 in FIG. 3. In some embodiments, the batch-norm unit 440 may be coupled with or include one or more data storage units. Batch normalization parameters may be embedded in the one or more data storage units. The batch normalization parameters may be prearranged so when the calculation is done, it is a matter of retrieving the parameters from the one or more data storage units and running the add, multiply calculation with the input. That way, data movement can be minimized. In some embodiments, a data storage unit may be a DRAM or ROM (e.g., a sequential read-only memory). In other embodiments, a data storage unit may be a SRAM, which can facilitate update of the batch normalization parameters by fine-tuning at least part of the CNN. The fining-tuning may be a LoRA fine-tuning. In some embodiments, the batch-norm unit 440 may include one or more processing units. Each processing unit may have one or more data storage units, one or more multipliers, and one or more adders. The processing units may be arranged in an array.

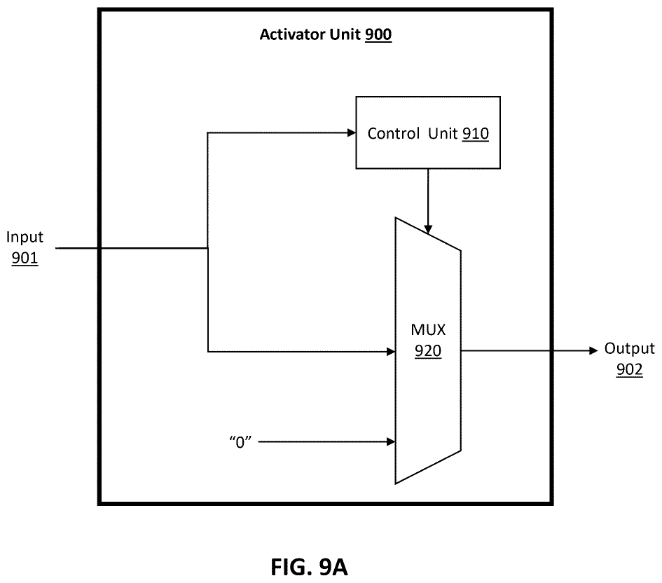

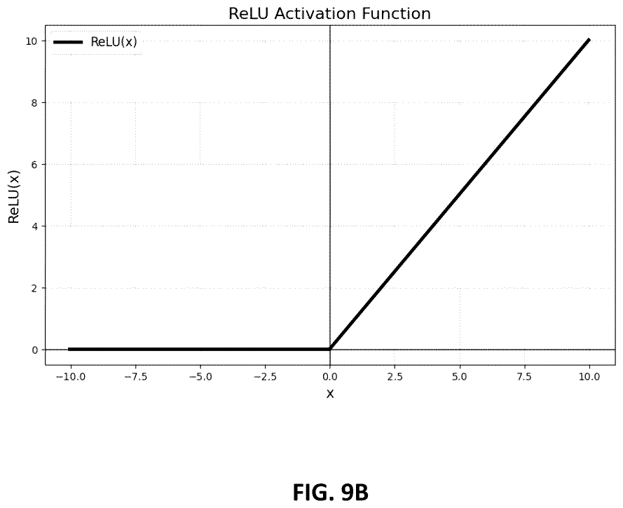

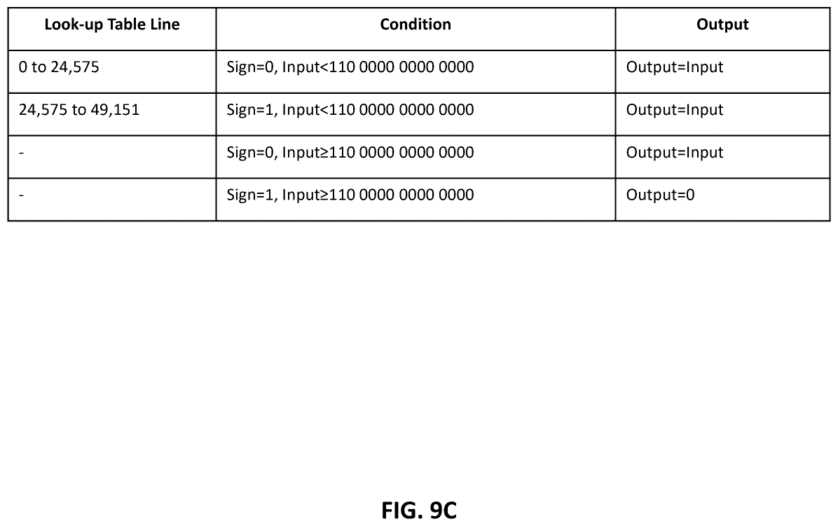

The ReLU unit 445 is a hardware implementation of one or more ReLU activation functions in the CNN. For instance, the ReLU activation function 130 in FIG. 1, ReLUs 230 in FIG. 2, and ReLUs 330 in FIG. 3 can be embedded onto the ReLU unit 445. Certain aspects of the ReLU unit 445 are described below in conjunction with FIGS. 9A-9C.

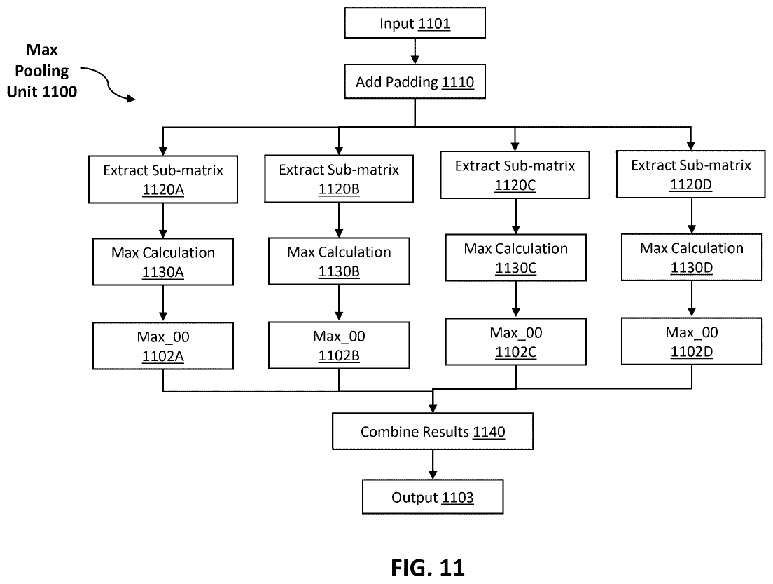

The max pooling unit 450 is a hardware implement of one or more max pooling operations in the CNN. For instance, the max pooling 140 in FIG. 1 can be embedded onto the max pooling unit 450. In some embodiments, the max pooling unit 450 may pad an input tensor, extract sub-tensors from the padded input tensor, determine maximum values of the sub-tensors, and generate an output tensor. Certain aspects of the max pooling unit 450 are described below in conjunction with FIG. 11.

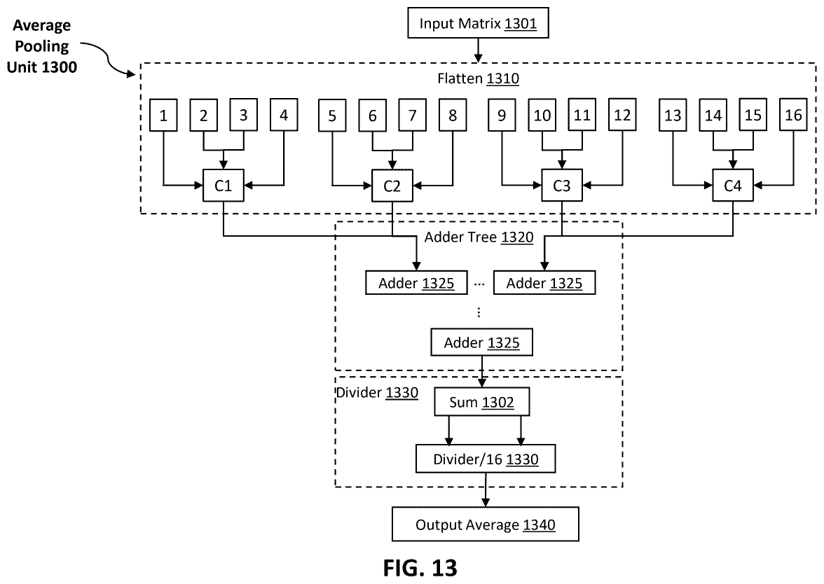

The average pooling unit 455 is a hardware implement of one or more average pooling operations in the CNN. For instance, the average pooling 160 in FIG. 1 can be embedded onto the average pooling unit 455. In some embodiments, the average pooling unit 455 may flatten an input tensor, compute average values, and generate an output tensor. Certain aspects of the average pooling unit 455 are described below in conjunction with FIG. 13.

The embedding dot unit 460 is a hardware implementation of MatMul operators and add operators in the CNN. For instance, MatMul 170 in FIG. 1, the addition 240 in FIG. 2, or the addition 340 in FIG. 3 can be embedded onto the embedding dot unit 460. The embedding dot unit 460 may also be referred to as a MatMul unit. In some embodiments, the embedding dot unit 460 may include a tree adder and multipliers. The tree adder may also be referred to as an adder tree and may include adders arranged in a tree structure. In one implementation, the embedding dot unit 460 may carry out a dot product operation between an embedding vector and a weight matrix. The dot product operation can be performed using one or more tree adders and one or more multipliers in the embedding dot unit 460. A multiplier may multiple two values, such as two floating-point values. The two values may have different data formats or precisions. For example, the embedding dot unit 460 may include one or more FP4/FP6 multipliers, one or more FP4/FP8 multipliers, or one or more FP6/FP8 multipliers. One or more multipliers in the embedding dot unit 460 may be specifically designed to perform multiplication of values or data having predetermined representations (e.g., FP4, FP6, FP8, FP12, INT8, etc.).

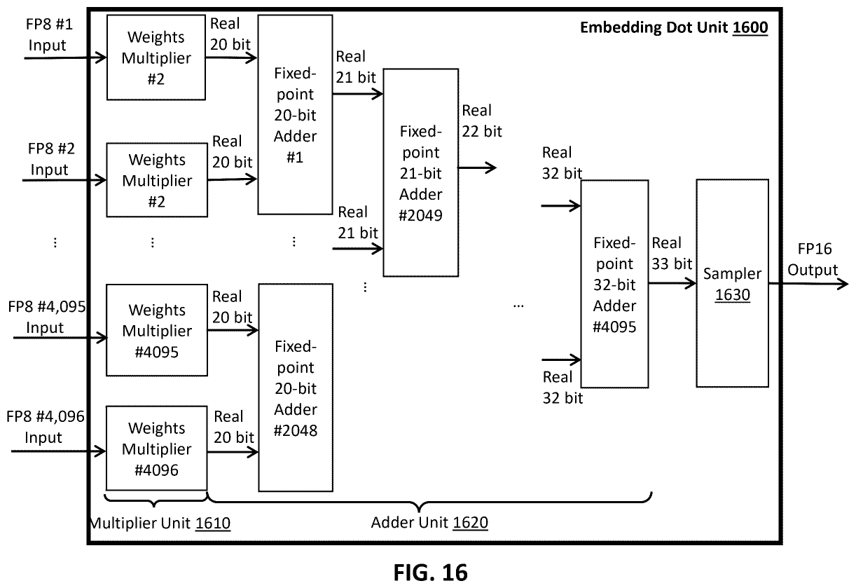

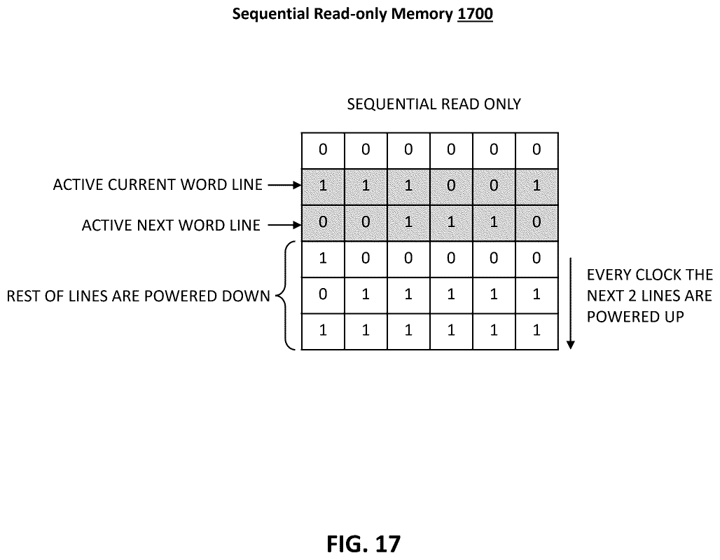

As shown in FIG. 4, the embedding dot unit 460 is coupled with the memories 475. The memories 475 may store and provide data (e.g., weights) to the embedding dot unit 460. In some embodiments, the memories 475 may be DRAMs. In other embodiments, the memories 475 may be ROMs, such as sequential read-only memories. In yet other embodiments, the memories 475 may be SRAMs, which can facilitate update of weights by fine-tuning at least part of the CNN. The fining-tuning may be a LoRA fine-tuning. The memories 475 may be placed in proximity to the components performing logic operations in the embedding dot unit 460, such as multipliers in the embedding dot unit 460. Each multiplier may be coupled with and proximate to a corresponding memory 475 and may receive data (e.g., one or more weights) from the memory 475. As data is located where it is needed, the embedding dot unit 460 can be very efficient. One or more tree adders may add multiplication results produced by one or more multipliers together. Certain aspects of the embedding dot unit 460 are described below in conjunction with FIG. 16. Certain aspects of the memories 475 are described below in conjunction with FIG. 17.

FIG. 5 illustrates an embedder unit 500, in accordance with various embodiments. The embedder unit 500 may execute an embedder associated with or included in a CNN. The embedder unit 500 may be an example of the embedder unit 410 in FIG. 4. As shown in FIG. 5, the embedder unit 500 includes 256 look-up tables. In other embodiments, the embedder unit 500 may include a different number of look-up tables. The look-up tables may have the same storage size, e.g., 1000 KB. Each of the look-up tables may have 512,000 lines. In some embodiments, the look-up tables may be implemented on one or more ROMs. In an example, the 256 look-up tables are implemented on 256 ROMs, respectively.

The embedder unit 500 may receive an input token. In the example shown in FIG. 5, the embedder unit 500 receives an input token represented by 15 bits. The input token may have an integer format. The embedder unit 500 may also receive control signals. For instance, the embedder unit 500 receives an embedder cycle signal (shown as “cycle” in FIG. 5), which may have 4 bits. The embedder unit 500 also receives an embedder run signal (shown as “run” in FIG. 5), which may have 1 bit. Even though not shown in FIG. 5, the embedder unit 500 may also receive an embedder on/off signal, which may have 1 bit.

The output of the embedder unit 500 is an embedding tensor of the input token. For instance, the embedder unit 500 may produce an embedding tensor with floating-point (e.g., FP16) data elements. The dimension of the embedding tensor may indicate the total number of data elements in the embedding vector. In an example of an embedding vector, the dimension of the embedding vector may be 4,096. In some embodiments, the embedder unit 500 may receive 32,000 tokens. The total embedder size may be 250 MB, which equals 4,096×32,000×2B. Each of the tokens may be broken into 16 chunks of 256 numbers. In some embodiments (e.g., embodiments where the look-up tables are stored in ROMs), the first out of 16 numbers may be read from the table. Reading from the ROM may be sequential for 16 cycles, so the next line is to be pre-charged but it may be unnecessary to pre-charge other lines. As shown in FIG. 5, within each cycle, the 256 look-up tables may output 256 embedding elements, respectively. The embedder unit 500 may return 256 elements every clock cycle for 16 clocks cycles. After finishing the 16 cycles, the embedder unit 500 may be idle for about 10,000 cycles. Power gating may be used.

FIG. 6A illustrates an exemplary convolution, in accordance with various embodiments. The convolution may be an example of the convolution 110 in FIG. 1, convolutions 210 in FIG. 2, or convolutions 310 in FIG. 3. For the purpose of illustration, FIG. 6A shows an input feature map 601, which is a (5,5) 2D tensor. The convolution has padding (1,1), so a row is added to the top and bottom of the input feature map 601. Also, a column is added to the left and right of the input feature map 601. The row or column may be a row or column of zeros. The added elements (i.e., padding elements) are shown by boxes with a dotted pattern in FIG. 6A. With the padding the input feature map 601 becomes a padded feature map 602, which is a (7,7) 2D tensor.

The convolution has a kernel 603, the size of which is 3. As shown in FIG. 6A, the kernel 603 is a (3,3) 2D tensor. The kernel 603 slides over the padded feature map 602 down and to the right, as indicated by the two arrows in FIG. 6A. The convolution has a stride (1,1), meaning the kernel 603 slides one column when it slides over the padded feature map 602 to the right and slides one row when it slides over the padded feature map 602 down. For each time the kernel 603 slide over the padded feature map 602, a product is computed by multiplying the kernel 603 with the part of the padded feature map 602 that overlaps with the kernel 603. The product is an element in an output feature map 604. As shown in FIG. 6A, the output feature map 604 is a (5,5) 2D tensor. In embodiments where padding is not performed, the output feature map would be a (3,3) 2D tensor. By padding the input feature map 601, the spatial dimensions of the feature map can be consistent, and data loss at the edges can be avoided.

FIG. 6B illustrates another exemplary convolution, in accordance with various embodiments. The convolution may be an example of the convolution 110 in FIG. 1, convolutions 210 in FIG. 2, or convolutions 310 in FIG. 3. In the example shown in FIG. 6B, the convolution can be executed on an activation tensor 610 and filters 620 (individually referred to as “filter 620”). The filters may constitute a weight tensor of the convolution. The result of the convolution is an output tensor 630. In some embodiments, the convolution is performed by an IC device, e.g., a convolution unit or processing unit in an IC device.

The activation tensor 610 may be computed in a previous operation of the DNN. In some embodiments (e.g., embodiments where the convolution is the operation of the DNN), the activation tensor 610 may be a feature map converted from an input image. In the embodiments of FIG. 6B, the activation tensor 610 includes activations (also referred to as “input activations,” “elements,” or “input elements”) arranged in a 3D matrix. The activation tensor 610 may also be referred to as an input tensor of the convolution. An input element is a data point in the activation tensor 610. The activation tensor 610 has a spatial size Hᵢₙ×Wᵢₙ×Cᵢₙ, where Hᵢₙ is the height of the 3D matrix (i.e., the length along the Y axis, which indicates the number of activations in a column in the 3D matrix of each input channel), Wᵢₙ is the width of the 3D matrix (i.e., the length along the X axis, which indicates the number of activations in a row in the 6D matrix of each input channel), and Cᵢₙ is the depth of the 3D matrix (i.e., the length along the Z axis, which indicates the number of input channels). For the purpose of simplicity and illustration, the activation tensor 610 has a spatial size of 7×7×3, i.e., the activation tensor 610 includes three input channels and each input channel has a 7×7 6D matrix. Each input element in the activation tensor 610 may be represented by a (X, Y, Z) coordinate. In other embodiments, the height, width, or depth of the activation tensor 610 may be different.

Each filter 620 includes weights arranged in a 3D matrix. The values of the weights may be determined through training the DNN. A filter 620 has a spatial size H_{f}×W_{f}×C_{f}, where H_{f} is the height of the filter (i.e., the length along the Y axis, which indicates the number of weights in a column in each kernel), W_{f} is the width of the filter (i.e., the length along the X axis, which indicates the number of weights in a row in each kernel), and C_{f} is the depth of the filter (i.e., the length along the Z axis, which indicates the number of channels). In some embodiments, C_{f} equals Cᵢₙ. For purpose of simplicity and illustration, each filter 620 in FIG. 6B has a spatial size of 6×3×3, i.e., the filter 620 includes 6 convolutional kernels with a spatial size of 6×3. In other embodiments, the height, width, or depth of the filter 620 may be different. The spatial size of the convolutional kernels is smaller than the spatial size of the 6D matrix of each input channel in the activation tensor 610.

An activation or weight may take one or more bytes in a memory. The number of bytes for an activation or weight may depend on the data format. For example, when the activation or weight has an INT8 format, the activation takes one byte. When the activation or weight has a FP16 format, the activation or weight takes two bytes. Other data formats may be used for activations or weights.

In the convolution, each filter 620 slides across the activation tensor 610 and generates a 6D matrix for an output channel in the output tensor 630. In the embodiments of FIG. 6B, the 6D matrix has a spatial size of 5×5. The output tensor 630 includes activations (also referred to as “output activations,” “elements,” or “output element”) arranged in a 3D matrix. An output activation is a data point in the output tensor 630. The output tensor 630 has a spatial size Hₒᵤₜ×Wₒᵤₜ×Cₒᵤₜ, where Hₒᵤₜ is the height of the 3D matrix (i.e., the length along the Y axis, which indicates the number of output activations in a column in the 6D matrix of each output channel), Wₒᵤₜ is the width of the 3D matrix (i.e., the length along the X axis, which indicates the number of output activations in a row in the 6D matrix of each output channel), and Cₒᵤₜ is the depth of the 3D matrix (i.e., the length along the Z axis, which indicates the number of output channels). Cₒᵤₜ may equal the number of filters 620 in the convolution. Hₒᵤₜ and Wₒᵤₜ may depend on the heights and weights of the activation tensor 610 and each filter 620. In an example where the kernel size is 1×1, Hₒᵤₜ and Wₒᵤₜ may equal to Hᵢₙ and Wᵢₙ, respectively.

As a part of the convolution, MAC operations can be performed on a 6×3×3 subtensor 615 (which is highlighted with a dotted pattern in FIG. 6B) in the activation tensor 610 and each filter 620. The result of the MAC operations on the subtensor 615 and one filter 620 is an output activation. In some embodiments (e.g., embodiments where the convolution is an integral convolution), an output activation may include 8 bits, e.g., one byte. In other embodiments (e.g., embodiments where the convolution is a floating-point convolution), an output activation may include more than one byte. For instance, an output element may include two bytes.

After the MAC operations on the subtensor 615 and all the filters 620 are finished, a vector 635 is produced. The vector 635 is highlighted with a dotted pattern in FIG. 6B. The vector 635 includes a sequence of output activations, which are arranged along the Z axis. The output activations in the vector 635 have the same (x, y) coordinate, but the output activations correspond to different output channels and have different Z coordinates. The dimension of the vector 635 along the Z axis may equal the total number of output channels in the output tensor 630. After the vector 635 is produced, further MAC operations are performed to produce additional vectors till the output tensor 630 is produced. In the embodiments of FIG. 6B, the output tensor 630 is computed in a Z-major format. When the output tensor 630 is computed in the ZXY format, the vector that is adjacent to the vector 635 along the X axis may be computed right after the vector 635. When the output tensor 630 is computed in the ZYX format, the vector that is adjacent to the vector 635 along the Y axis may be computed right after the vector 635.

In some embodiments, the MAC operations on a 3×3×3 subtensor (e.g., the subtensor 615) and a filter 620 may be performed by a plurality of MAC units. One or more MAC units may receive an input operand (e.g., an activation operand 617 shown in FIG. 6B) and a weight operand (e.g., the weight operand 627 shown in FIG. 6B). The activation operand 617 includes a sequence of activations having the same (x, y) coordinate but different z coordinates. The activation operand 617 includes an activation from each of the input channels in the activation tensor 610. The weight operand 627 includes a sequence of weights having the same (x, y) coordinate but different z coordinates. The weight operand 627 includes a weight from each of the channels in the filter 620. Activations in the activation operand 617 and weights in the weight operand 627 may be sequentially fed into a MAC unit. The MAC unit may receive an activation and a weight (“an activation-weight pair”) at a time and multiple the activation and the weight. The position of the activation in the activation operand 617 may match the position of the weight in the weight operand 627. The activation and weight may correspond to the same channel.

Activations or weights may be floating-point numbers. Floating-point numbers may have various data formats, such as FP32, FP16, BF16, and so on. A floating-point number may be a positive or negative number with a decimal point. A floating-point number may be represented by a sequence of bits that includes one or more bits representing the sign of the floating-point number (e.g., positive or negative), bits representing an exponent of the floating-point number, and bits representing a mantissa of the floating-point number. The mantissa is the part of a floating-point number that represents the significant digits of that number. The mantissa is multiplied by the base raised to the exponent to give the actual value of the floating-point number.

FIG. 7 illustrates an exemplary workflow of a convolution unit, in accordance with various embodiments. The convolution unit is an example of the convolution unit 435 in FIG. 4. For the purpose of illustration, the workflow in FIG. 7 starts with initialization. In the initialization step, the convolution unit may initialize the sum to zero. The convolution unit may also reset the output feature map (“cov_out”), e.g., when the reset signal (“rst”) is high. This can ensure that the system starts a known state.

The next step is outer loop, which may be image traversal with stride. The outer loop may iterate over each position in the input feature map, where the kernel may be applied. A position may be denoted as (i,j), where i may indicate which column the element is in, and j may indicate which row the element is in. The loop may increment by the stride value (“STRIDE”), enabling the kernel to slide across the input image.

The next step is window extraction. For each position (i,j), a KERNEL_SIZE×KERNEL_SIZE window may be extracted from the input feature map starting at position (i×STRIDE,j×STRIDE). This window may represent the portion of the input feature map that overlaps with the kernel at this position.

The next step is inner loop, which may be kernel traversal. The inner loop may iterate over each element (kᵢ,kⱼ) of the kernel.

The next step is elementwise multiplication. During each iteration of the inner loop, the corresponding elements of the extract window and the kernel are multiplied together. The result of the multiplication may be stored in “mult_result.”

The next step is summation. The products of the elementwise multiplication are accumulated to form a single sum. This sum may represent the convolution result for the current position (i,j) in the input feature map. The sum may be an output activation.

The last step is output assignment. The accumulation sum is assigned to the corresponding position in the output feature map (“conv_out”). This may complete the convolution operation for the current position (i,j). After the output assignment, the initialization step may be performed again for the next position, e.g., position (i+1,j). The subsequent steps may be perform to compute the accumulation sum for the next position. This process may continue till all the positions in the input feature map are done.

FIGS. 8A and 8B illustrate execution of 2D convolution by a convolution unit 830, in accordance with various embodiments. The convolution unit 830 may be an example of the convolution unit 435 in FIG. 4. The convolution unit 830 may perform the workflow shown in FIG. 7 to execute convolution. A shown in FIG. 8A, the convolution unit 830 is associated with a data_in unit 810, a kernel unit 820, and a control unit 840. In some embodiments, the data_in unit 810, kernel unit 820, or control unit 840 may be part of the convolution unit 830.

In some embodiments, the control unit 849 provides a reset signal (“rst”) to the convolution unit 830. The convolution unit 830 may initialize sum and reset output based on the reset signal, as shown in FIG. 8B. After the convolution unit 830 initializes the sum, the convolution unit 830 may perform one or more MAC operations on data from the in unit 810 and kernel unit 820. As shown in FIG. 8B, the data_in unit 810 provides input data, e.g., an input feature map, and the kernel unit 820 provides kernel data to the convolution unit 830. The convolution unit 830 computes a convolution output from the input data and kernel data and update the convolution output.

FIGS. 9A-9C illustrate an activator unit 900, in accordance with various embodiments. The activator unit 900 may be an example of the ReLU unit 445 in FIG. 4. FIG. 9A shows an architecture of the activator unit 900. FIG. 9B shows a curve representing the ReLU activation function executed by the activator unit 900.

As shown in FIG. 9A, the activator unit 900 includes a control unit 910 and a MUX 920. In other embodiments, the activator unit 900 may include fewer, more, or different components. An input 901 is provided to the control unit 910 and MUX 920. The control unit 910 may receive most significant bits (MSBs), such as 3-bit MSB, of the input 901. These bits may indicate a sign of the input 901. The control unit 910 may generate a control signal based on these bits. The output of the control unit 910 may be a 2-bit control signal. The MUX 920 may receive two signals: the input 901 and zero. The MUX 920 may select one of the two signals based on the control signal from the control unit 910. In an example, the MUX 920 selects the input 901 as its output when the sign of the input 901 is positive. In another example, the MUX 920 selects zero as its output when the sign is negative. The output of the MUX 920 may be the output of the activator unit 900, which is either a positive value or zero.

FIG. 9C shows a table that describes the conditions and outputs for the ReLU function based on the input value and its sign bit. The table shows how different ranges of inputs are processed and the corresponding output values. The look-up table shown in FIG. 9C may be a part of the activator unit 900.

FIG. 10 illustrates a max pooling operation 1000, in accordance with various embodiments. The max pooling operation 1000 may be a neural network operation in a CNN, e.g., the CNN 100. The max pooling operation 1000 can be used to reduce the spatial dimensions (e.g., height and width) of the input volume, which helps in decreasing the computational load and reducing overfitting. The max pooling operation 1000 involves sliding a window (e.g., a 2×2 window) over the input feature map and taking the maximum value within the window. The max pooling operation 1000 may be an example of the max pooling 140 in FIG. 1.

In the example shown in FIG. 10, the max pooling operation 1000 has an input matrix 1010, which has 16 elements arranged in four rows and four columns. A padding is performed to convert the input matrix 1010 to a padded matrix 1020 by adding two rows of zeros and two columns of zeros to the four edges of the input matrix 1010. The padded matrix 1020 has 36 elements arranged in six columns and six rows. The padded matrix 1020 is divided into four windows, each window is a (2, 2) submatrix within the padded matrix 1020. The largest value in each submatrix is identified. The largest value of the first submatrix is 6, the largest value of the second submatrix is 8, the largest value of the third submatrix is 14, and the largest value of the fourth submatrix is 16. These four values constitute an output matrix 1030, which is the output of the max pooling operation 1000.

The max pooling operation 1000 can help in progressively reducing the spatial dimensions of the feature maps while preserving the most important features, enabling the network to focus on higher-level abstractions. The max pooling operation 1000 may be followed by other layers such as convolutional layers and ReLU activations to further process the data.

FIG. 11 illustrates a workflow of a max pooling unit 1100, in accordance with various embodiments. The max pooling unit 1100 may be an example of the max pooling unit 450 in FIG. 4. The workflow includes a sequence of steps. As shown in FIG. 11, the workflow starts with an input 1101. The max pooling unit 1100 adds padding to the input 1101 in Step 1110. The result of the padding is a padded input, which is a larger matrix than the input 1101. The max pooling unit 1100 extracts four submatrices from the padded input in four steps 1120A-1120D, respectively. The four steps 1120A-1120D may be performed sequentially, in parallel, or a combination of both. Then the max pooling unit 1100 calculates four max values 1102A-1102D in four steps 1130A-1130D, respectively. Each max value is the largest value in the corresponding submatrix. Then the max pooling unit 1100 outputs the max values 1102A-1102D. Further, the max pooling unit 1100 combines the max values in Step 1140, which generates an output 1103 of the max pooling operation. In some embodiments, values in the input 1101 or output 1103 may have a 16-bit data format, such as FP16, BF16, and so on.

FIG. 12 illustrates an average pooling operation 1200, in accordance with various embodiments. The average pooling operation 1200 may be an example of the average pooling 160 in FIG. 1. As shown in FIG. 12, the average pooling operation 1200 has an input matrix 1210. The input matrix 1210 is a (4, 4) tensor. The input matrix 1210 is divided into four windows, each window is a (2, 2) submatrix within the input matrix 1210. The average of the four values in each submatrix is calculated. These four average values constitute an output matrix 1220, which is the output of the average pooling operation 1200. In some embodiments, the input to the average pooling operation 1200 may be a 3D tensor that has multiple channels. The average pooling operation 1200 may be performed on the 2D tensor of each channel separately. The average pooling operation 1200 can reduce the spatial dimensions of the feature maps while preserving the depth (i.e., the number of channels). The average pooling operation 1200 can help down sample the input, reducing computational complexity and aiding in the extraction of the most significant features.

FIG. 13 illustrates a workflow of an average pooling unit 1300, in accordance with various embodiments. The average pooling unit 1300 may be an example of the average pooling unit 455 in FIG. 4. The workflow includes a sequence of steps. As shown in FIG. 11, the workflow starts with an input matrix 1301. The average pooling unit 1300 flattens the input matrix 1301 in Step 1310. For the purpose of illustration and simplicity, the input matrix 1301 is the input matrix 1210 in FIG. 12.

The 16 elements in the input matrix 1301 are then provided to an adder tree 1320 in the average pooling unit 1300. The adder tree 1320 adds the elements together and computes a sum 1302. This step combines the values of the matrix elements. The adder tree 1320 includes adders 1325 (individually referred to as “adder 1325”) that are arranged in a tree or hierarchical structure. For instance, each adder in the first tier of the tree structure may receive two elements in the input matrix 1301 and computes a sum. Each adder in the second tier may receive two sums computed in the first tier. This may continue, and the last tier may have a single adder to compute the final sum. A tier may be a level or layer. The sum 1302 is then divided by the number of elements, i.e., 16, in Step 1330. Further, the average pooling unit 1300 outputs the average in Step 1340.

In some embodiments, the input matrix 1301 may be partitioned into submatrices and an average may be computed for each submatrix. The output may be a matrix, which is smaller than the input matrix 1301.

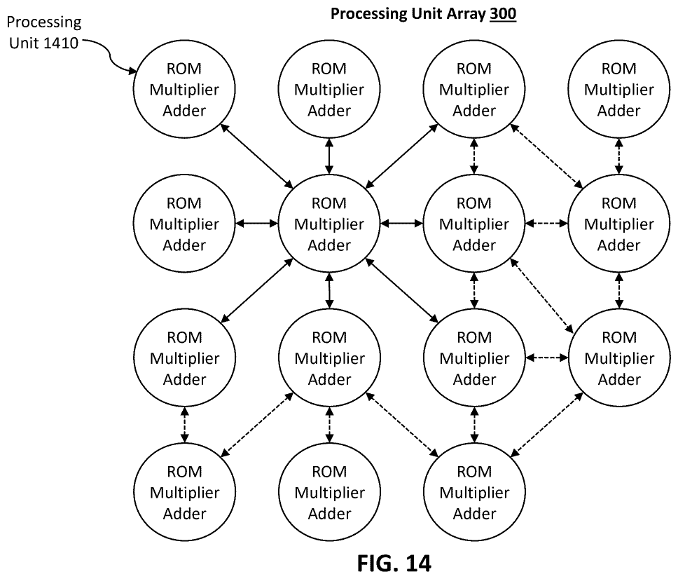

FIG. 14 illustrates a processing unit array 1400, in accordance with various embodiments. The processing unit array 1400 may be part of an IC device, e.g., the IC device 400 in FIG. 4. The processing unit array 1400 may perform neural network operations in a CNN (e.g., the CNN 100 in FIG. 1) using small, interconnected units. Each unit may perform operations like convolution, ReLU, and batch normalization by utilizing simple arithmetic functions such as addition and multiplication.

As shown in FIG. 14, the processing unit array 1400 includes a plurality of processing units 1410, individually referred to as “processing unit 1410.” In the example shown in FIG. 14, each processing unit 1410 has a ROM, a multiplier, and an adder. In other embodiments, a processing unit may include fewer, more, or different components. For instance, a processing unit may include multiple ROMs, multipliers, or adders. Further, a processing unit may include a different type of memory in addition or alternative to the ROM. For instance, a processing unit may include a DRAM. Each processing unit 1410 has its own dedicated data storage unit where weights or other data for the specific neural network operation are stored. This can minimize data movement within the chip, enhancing computation efficiency. The multipliers and adders can perform the requirement computation for convolution, ReLU, and batch normalization in the CNN.

The arrows in FIG. 14 shows data flow among the processing units 1410. The data may flow from one unit to the next in a pipelined manner. Each unit can process its input data in one hardware clock cycle and then pass the result to its neighboring unit. Data other than the results from each unit may not be passed to the next, reducing the amount of data movement within the chip. This is efficient in terms of power and speed.

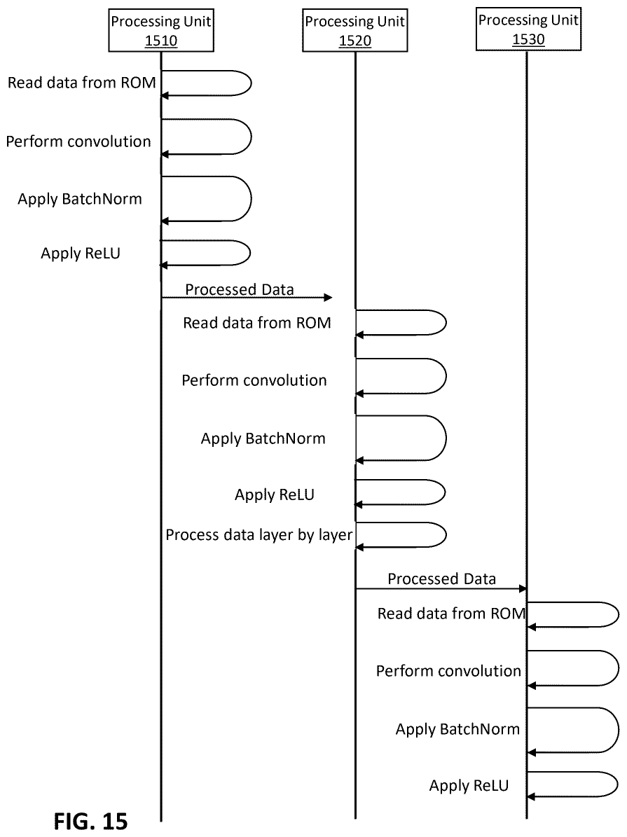

FIG. 15 illustrates sequential operations performed by a processing unit array, in accordance with various embodiments. An example of the processing unit array is the processing unit array 1400 in FIG. 14. For the purpose of illustration, FIG. 15 shows three processing units 1510, 1520, and 1530 in the processing unit array. The processing unit array may include other processing units. Further, computations performed by any one of the processing units 1510, 1520, and 1530 may be performed by multiple processing units that are communicatively coupled to each other.

In some embodiments, the processing unit 1510 may be the first processing unit in the processing unit array. The processing unit 1520 may represent an intermediate unit in the processing unit array. The processing unit 1530 may be the last processing unit in the processing unit array.

The processing unit 1510 may read data from its own memory. In some embodiment (e.g., embodiments where the internal parameters of the CNN are fixed), the memory may be a DRAM or ROM. In other embodiments (e.g., embodiments where the processing unit array may update internal parameters of the CNN by fine-tuning the model), the memory may be a SRAM. The fining-tuning may be a LoRA fine-tuning, which may provide 2% update. The processing unit 1510 may perform a convolution operation, which may involve one or more multipliers and one or more adders to apply filters to the input data. The processing unit 1510 may further perform batch normalization on the output tensor of the convolution. To perform the batch normalization, the processing unit 1510 may read additional data from the memory. The additional data may be batch normalization parameters described above. The batch normalization may involve one or more multipliers and one or more adders to standardize the inputs. The processing unit 1510 may also apply a ReLU activation function, which may introduce non-linearity. The processing unit 1510 may transmit data (e.g., the result of the ReLU activation function) to the processing unit 1520. The data may be stored in the memory of the processing unit 1520.

The processing unit 1520 may perform similar steps as the processing unit 1510. For instance, the processing unit 1520 may read data from its own memory, then perform convolution, batch normalization, and ReLU activation. The resulting data may be transmitted to the next intermediate unit. This may continue until the last processing unit is reached.

The processing unit 1530 may perform a similar sequence of operations as the processing unit 1520, which includes reading data from its own memory, performing convolution, applying batch normalization function, and applying ReLu activation function. The final data computed by the processing unit 1530 may be the output of the CNN. In some embodiments, the processing unit array may execute one or more layers of the CNN, such as the layers 151-154. The output of the processing unit array may be an output feature map of a layer.

FIG. 16 illustrates an embedding dot unit 1600, in accordance with various embodiments. The embedding dot unit 1600 may execute one or more MaxMut operations or additions in a CNN. The embedding dot unit 1600 may be an example of the embedding dot unit 460 in FIG. 4.

As shown in FIG. 16, the embedding dot unit 1600 includes a multiplier unit 1610, an adder unit 1620, and a sampler 1630. In other embodiments, the embedding dot unit 1600 may include fewer, more, or different components. The multiplier unit 1610 may perform elements dot product operation between an embedding vector (e.g., FP8 embedding vector) and a weights vector (e.g., FP6 weights vector read from sequential read-only memory) every cycle. The multiplier unit 1610 includes a plurality of weights multipliers. In an example of FIG. 16, the embedding dot unit 1600 may include 4,096 weights multipliers: weights multiplier #1 through weights multiplier #4,096. The weights multipliers may perform multiplication in parallel. The outputs (e.g., 4096 outputs) may be added together by the adder unit 1620.

In the example of FIG. 16, the adder unit 1620 includes 4,095 adders. These adders are arranged in a tree or hierarchical structures. In some embodiments, the adder unit 1620 may use a special fixed-point adder with a relatively large number of bits (e.g., 20 bits, 21 bits, . . . 32 bits). The 4,095 adders may be arranged in 16 tiers. The first tier includes 2,048 adders, for instance. Each adder in the first tier sums two products from two weights multipliers, respectively. Each adder in the second tier sums the outputs of two adders in the first tier. Each adder in the third tier sums the outputs of two adders in the second tier. This continues till adder #4095 is reached. The adder in the 16th tier outputs the final sum, which may be a 33-bit number, which is then provided to the sampler 1630. The sampler 1630 may be a FP16 sampler. The sampler 1630 may resample the final sum into a floating-point representation. The embedding dot unit 1600 may generate an FP16 output. Using a large number of bits in the adder unit 1620 can prevent overflow during many stages/layers of adding.

FIG. 17 illustrates a sequential read-only memory 1700, in accordance with various embodiments. Sequence read-only memory is a type of memory storage, utilizing ROMs, that allows data to be read sequentially but not written or modified after the values have been etched onto the ROM. The rest of the ROM can be shut down to reduce power and area. In some embodiments, the sequential read-only memory 1700 may be a memory in an IC device implementing a DNN, such as the IC device 400 in FIG. 4. The IC device may include multiple sequential read-only memories. The sequential read-only memory 1700 may be an example of the memories 465 in FIG. 4.

For the purpose of illustration, the sequential read-only memory 1700 in FIG. 17 has six word lines. The sequential read-only memory 1700 can power up an active current word line and an active next word line at a time, while other word lines can be powered down. The active current word line refers to the word line having data being used or processed by a circuit to perform an operation during a time slot in the predetermined timing sequence. The active next word line refers to the word line having data being used or processed by the circuit to perform an operation during a further/next time slot in the predetermined timing sequence. The sequential read-only memory 1700 can power down the rest of the word lines, or the rest of the word lines in the sequential read-only memory 1700 can remain powered down. At the next clock or time slot, the active current word line is powered down, the active next word line is already powered up, and a further active next word line is powered up. At every clock or time slot, two word lines may be powered up in the sequential read-only memory 1700. The two active word lines that are powered up may get moved by one word line down the sequential read-only memory at every clock or time slot.

In some embodiments, an IC device implementing a DNN may have 1,048,576 ROMs (e.g., sequential read-only memories) for storing weights. A ROM may hold weights in FP6 format. A ROM output may be a 6-bit value. A weights ROM may hold a specific weight matrix column, since a weights ROM can output a single number out of the 4096-element vector being multiplied in the EDU. A weights ROM may hold one of 256 weight matrix rows, e.g., when there are 256 embedding dot units working in parallel and producing 256 numbers per clock cycle. A ROM may hold matrix rows 1, 257, . . . , and another ROM can hold matrix rows 2, 258, and so forth. In some cases, a weights ROM may hold elements from (all) weights matrices in (all) layers, since a weights ROM sequentially outputs the number the matrix multiplier is using for (all) transformers and matrices, as the weights multipliers are shared across all layers and weights matrices. The weights ROM may hold (only) the linear layers' weights. There may be one or more dedicated ROMs for the embedder unit and layer normalizer unit.

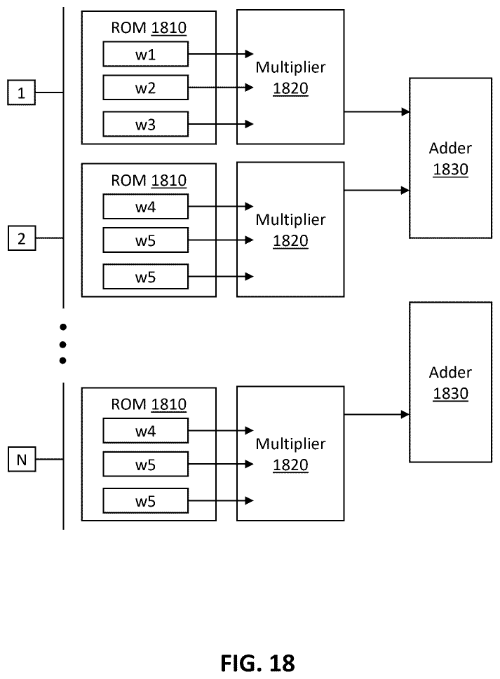

FIG. 18 illustrates sequential ROMs proximate to multipliers, in accordance with various embodiments. For the purpose of illustration, FIG. 18 shows N ROMs 1810, individually referred to as “ROM 1810”. An example of the ROMs 1810 may be the sequential read-only memory 1700 in FIG. 17. Each ROM 1810 stores three weights. Each ROM 1810 corresponds to a multiplier 1820, which receives weights from the ROM 1810. In some embodiments, the ROM 1810 may be integrated with the multiplier 1820. The multiplier 1820 may computer one or more products from the weights. The products computed by two adjacent multipliers are provided to an adder 1830 to compute a sum of the two products. With such a configuration, no RAM or cache is needed. Also, data is located where needed. It can be deterministic. Compared with currently available solutions, each ROM 1810 is physically close to the multiplier 1820 that uses it. DNN inference using such as hardware configuration can be extremely fast as data is located where it is needed.

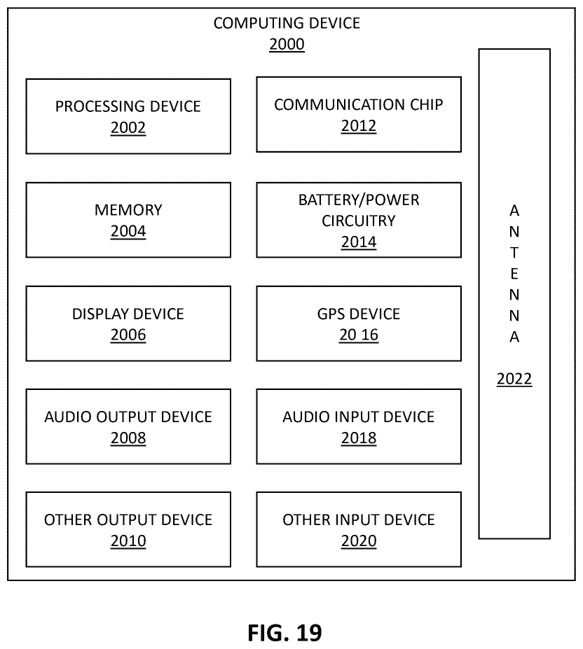

FIG. 19 is a block diagram of an example computing device 2000, in accordance with various embodiments. A number of components are illustrated in FIG. 19 as included in the computing device 2000, but any one or more of these components may be omitted or duplicated, as suitable for the application. In some embodiments, some or all of the components included in the computing device 2000 may be attached to one or more motherboards. In some embodiments, some or all of these components are fabricated onto a single SoC die. Additionally, in various embodiments, the computing device 2000 may not include one or more of the components illustrated in FIG. 19, but the computing device 2000 may include interface circuitry for coupling to the one or more components. For example, the computing device 2000 may not include a display device 2006, but may include display device interface circuitry (e.g., a connector and driver circuitry) to which a display device 2006 may be coupled. In another set of examples, the computing device 2000 may not include an audio input device 2018 or an audio output device 2008 but may include audio input or output device interface circuitry to which an audio input device 2018 or audio output device 2008 may be coupled.

The computing device 2000 may include a processing device 2002 (e.g., one or more processing devices). The processing device 2002 processes electronic data from registers and/or memory to transform that electronic data into other electronic data that may be stored in registers and/or memory. The processing device 2002 may include one or more IC devices implementing speech recognition models, such as the IC device 400 in FIG. 4. The computing device 2000 may include a memory 2004, which may itself include one or more memory devices such as volatile memory (e.g., DRAM), nonvolatile memory (e.g., ROM), high bandwidth memory (HBM), flash memory, solid state memory, and/or a hard drive. In some embodiments, the memory 2004 may include memory that shares a die with the processing device 2002. In some embodiments, the memory 2004 includes one or more non-transitory computer-readable media storing instructions executable to perform operations, such as operations in speech recognition models. The instructions stored in the one or more non-transitory computer-readable media may be executed by the processing device 2002.

In some embodiments, the computing device 2000 may include a communication chip 2012 (e.g., one or more communication chips). For example, the communication chip 2012 may be configured for managing wireless communications for the transfer of data to and from the computing device 2000. The term “wireless” and its derivatives may be used to describe circuits, devices, systems, methods, techniques, communications channels, etc., that may communicate data through the use of modulated electromagnetic radiation through a nonsolid medium. The term does not imply that the associated devices do not contain any wires, although in some embodiments they might not.

The communication chip 2012 may implement any of a number of wireless standards or protocols, including but not limited to Institute for Electrical and Electronic Engineers (IEEE) standards including Wi-Fi (IEEE 802.10 family), IEEE 802.16 standards (e.g., IEEE 802.16-2005 Amendment), Long-Term Evolution (LTE) project along with any amendments, updates, and/or revisions (e.g., advanced LTE project, ultramobile broadband (UMB) project (also referred to as “3GPP2”), etc.). IEEE 802.16 compatible Broadband Wireless Access (BWA) networks are generally referred to as WiMAX networks, an acronym that stands for worldwide interoperability for microwave access, which is a certification mark for products that pass conformity and interoperability tests for the IEEE 802.16 standards. The communication chip 2012 may operate in accordance with a Global System for Mobile Communication (GSM), General Packet Radio Service (GPRS), Universal Mobile Telecommunications System (UMTS), High Speed Packet Access (HSPA), Evolved HSPA (E-HSPA), or LTE network. The communication chip 2012 may operate in accordance with Enhanced Data for GSM Evolution (EDGE), GSM EDGE Radio Access Network (GERAN), Universal Terrestrial Radio Access Network (UTRAN), or Evolved UTRAN (E-UTRAN). The communication chip 2012 may operate in accordance with Code-division Multiple Access (CDMA), Time Division Multiple Access (TDMA), Digital Enhanced Cordless Telecommunications (DECT), Evolution-Data Optimized (EV-DO), and derivatives thereof, as well as any other wireless protocols that are designated as 3G, 4G, 5G, and beyond. The communication chip 2012 may operate in accordance with other wireless protocols in other embodiments. The computing device 2000 may include an antenna 2022 to facilitate wireless communications and/or to receive other wireless communications (such as AM or FM radio transmissions).

In some embodiments, the communication chip 2012 may manage wired communications, such as electrical, optical, or any other suitable communication protocols (e.g., the Ethernet). As noted above, the communication chip 2012 may include multiple communication chips. For instance, a first communication chip 2012 may be dedicated to shorter-range wireless communications such as Wi-Fi or Bluetooth, and a second communication chip 2012 may be dedicated to longer-range wireless communications such as global positioning system (GPS), EDGE, GPRS, CDMA, WiMAX, LTE, EV-DO, or others. In some embodiments, a first communication chip 2012 may be dedicated to wireless communications, and a second communication chip 2012 may be dedicated to wired communications.

The computing device 2000 may include battery/power circuitry 2014. The battery/power circuitry 2014 may include one or more energy storage devices (e.g., batteries or capacitors) and/or circuitry for coupling components of the computing device 2000 to an energy source separate from the computing device 2000 (e.g., AC line power).

The computing device 2000 may include a display device 2006 (or corresponding interface circuitry, as discussed above). The display device 2006 may include any visual indicators, such as a heads-up display, a computer monitor, a projector, a touchscreen display, a liquid crystal display (LCD), a light-emitting diode display, or a flat panel display, for example.

The computing device 2000 may include an audio output device 2008 (or corresponding interface circuitry, as discussed above). The audio output device 2008 may include any device that generates an audible indicator, such as speakers, headsets, or earbuds, for example.

The computing device 2000 may include an audio input device 2018 (or corresponding interface circuitry, as discussed above). The audio input device 2018 may include any device that generates a signal representative of a sound, such as microphones, microphone arrays, or digital instruments (e.g., instruments having a musical instrument digital interface (MIDI) output).

The computing device 2000 may include a GPS device 2016 (or corresponding interface circuitry, as discussed above). The GPS device 2016 may be in communication with a satellite-based system and may receive a location of the computing device 2000, as known in the art.

The computing device 2000 may include another output device 2010 (or corresponding interface circuitry, as discussed above). Examples of the other output device 2010 may include an audio codec, a video codec, a printer, a wired or wireless transmitter for providing information to other devices, or an additional storage device.

The computing device 2000 may include another input device 2020 (or corresponding interface circuitry, as discussed above). Examples of the other input device 2020 may include an accelerometer, a gyroscope, a compass, an image capture device, a keyboard, a cursor control device such as a mouse, a stylus, a touchpad, a bar code reader, a Quick Response (QR) code reader, any sensor, or a radio frequency identification (RFID) reader.

The computing device 2000 may have any desired form factor, such as a handheld or mobile computer system (e.g., a cell phone, a smart phone, a mobile internet device, a music player, a tablet computer, a laptop computer, a netbook computer, an ultrabook computer, a personal digital assistant (PDA), an ultramobile personal computer, etc.), a desktop computer system, a server or other networked computing component, a printer, a scanner, a monitor, a set-top box, an entertainment control unit, a vehicle control unit, a digital camera, a digital video recorder, or a wearable computer system. In some embodiments, the computing device 2000 may be any other electronic device that processes data.

The following paragraphs provide various examples of the embodiments disclosed herein.

Example 1 provides an IC device, including a convolution unit to perform a convolution of a neural network, the convolution unit including a first memory, the first memory to store a kernel of the convolution; a batch-norm unit to apply a batch normalization function to a feature map computed by the convolution unit, the batch-norm unit including a second memory, the second memory to store one or more parameters of the batch normalization function; an activator unit to apply an activation function on a feature map computed by the batch-norm unit; and a pooling unit to down sample a feature map computed by the activator unit.

Example 2 provides the IC device of example 1, in which the activation function is Rectified Linear Unit, in which the activator unit including a multiplexer, the multiplexer to select a value between an element in the feature map computed by the batch-norm unit and zero.

Example 3 provides the IC device of example 1 or 2, in which the first memory or the second memory is a read-only memory.

Example 4 provides the IC device of example 1 or 2, in which the first memory or the second memory is a dynamic random-access memory.

Example 5 provides the IC device of any one of examples 1-4, in which the second memory is further to store the feature map computed by the convolution unit.

Example 6 provides the IC device of any one of examples 1-5, in which the activator unit further includes a third memory, the third memory to store the feature map computed by the batch-norm unit.

Example 7 provides the IC device of any one of examples 1-6, further including one or more memories; an embedding dot unit coupled with the one or more memories, the embedding dot unit including one or more adders and one or more multipliers, the embedding dot unit to perform a matrix multiplication operation in the neural network.

Example 8 provides the IC device of example 7, in which the one or more memories are of a same type as the first memory or the second memory.

Example 9 provides the IC device of any one of examples 1-8, in which the pooling unit is to perform a max pooling operation or an average pooling operation on the feature map computed by the activator unit.

Example 10 provides the IC device of any one of examples 1-9, in which the activation function is Rectified Linear Unit.

Example 11 provides an IC device, including an embedder unit including one or more look-up tables, the embedder unit to convert one or more input tokens of an input image into a feature map; and one or more etched mind units, an etched mind unit including a convolution unit to perform a convolution of a neural network on the feature map, the convolution unit including a first memory, the first memory to store a kernel of the convolution, a batch-norm unit to apply a batch normalization function to a feature map computed by the convolution unit, the batch-norm unit including a second memory, the second memory to store one or more parameters of the batch normalization function, and an activator unit to apply an activation function on a feature map computed by the batch-norm unit, the activator unit including a multiplexer, the multiplexer to select a value between an element in the feature map computed by the batch-norm unit and zero; and a flow control unit to orchestrate the embedder unit and one or more etched mind units based on a timing sequence of the neural network.

Example 12 provides the IC device of example 11, in which the first memory or the second memory is a read-only memory or a dynamic random-access memory.

Example 13 provides the IC device of example 11 or 12, in which the etched mind unit further includes one or more memories; and an embedding dot unit coupled with the one or more memories, the embedding dot unit including one or more adders and one or more multipliers, the embedding dot unit to perform a matrix multiplication operation in the neural network.

Example 14 provides the IC device of example 13, in which the one or more memories are of a same type as the first memory or the second memory.

Example 15 provides the IC device of any one of examples 11-14, in which the etched mind unit further comprises a pooling unit, the pooling unit to perform a max pooling operation on the feature map computed by the activator unit.

Example 16 provides the IC device of any one of examples 11-15, in which the activator unit further includes a third memory, the third memory to store the feature map computed by the batch-norm unit.

Example 17 provides the IC device of any one of examples 11-16, in which the second memory is further to store the feature map computed by the convolution unit.

Example 18 provides an IC device, including a first processing unit including a first memory, a first group of multipliers, and a first group of adders, the first processing unit to perform a sequence of neural network operations in a neural network; a second processing unit including a second memory, a second group of multipliers, and a second group of adders, the second processing unit to perform the sequence of neural network operations using data computed by the first processing unit; and a third processing unit including a third memory, a third group of multipliers, and a third group of adders, the third processing unit to perform the sequence of neural network operations in the neural network using data computed by the second processing unit.

Example 19 provides the IC device of example 18, in which the sequence of neural network operations includes a convolution, a batch normalization, and an activation function operation.

Example 20 provides the IC device of example 18 or 19, in which the first memory, the second memory, or the third memory is a read-only memory.

Example 21 provides the IC device of any one of examples 18-20, in which the first memory, the second memory, or the third memory is a dynamic random-access memory.

Example 22 provides the IC device of any one of examples 18-21, further including one or more additional processing units, an additional processing unit including an additional memory, an additional group of multipliers, and an additional group of adders.

Example 23 provides the IC device of any one of examples 18-22, in which the neural network is a convolutional neural network.

Example 24 provides the IC device of any one of examples 18-23, in which the IC device receives one or more tokens as an input and outputs one or more new tokens.

Example 25 provides the IC device of any one of examples 18-24, in which the first memory, the second memory, or the third memory is to store weights of the neural network.

The above description of illustrated implementations of the disclosure, including what is described in the Abstract, is not intended to be exhaustive or to limit the disclosure to the precise forms disclosed. While specific implementations of, and examples for, the disclosure are described herein for illustrative purposes, various equivalent modifications are possible within the scope of the disclosure, as those skilled in the relevant art can recognize. These modifications may be made to the disclosure in light of the above detailed description.

1. An integrated circuit (IC) device, comprising:
a convolution unit to perform a convolution of a neural network, the convolution unit comprising a first memory, the first memory to store a kernel of the convolution;
a batch-norm unit to apply a batch normalization function to a feature map computed by the convolution unit, the batch-norm unit comprising a second memory, the second memory to store one or more parameters of the batch normalization function;
an activator unit to apply an activation function on a feature map computed by the batch-norm unit; and
a pooling unit to down sample a feature map computed by the activator unit.

2. The IC device of claim 1, wherein the activator unit comprising a multiplexer, the multiplexer to select a value between an element in the feature map computed by the batch-norm unit and zero.

3. The IC device of claim 1, wherein the first memory or the second memory is a read-only memory.

4. The IC device of claim 1, wherein the first memory or the second memory is a dynamic random-access memory.

5. The IC device of claim 1, wherein the second memory is further to store the feature map computed by the convolution unit.

6. The IC device of claim 1, wherein the activator unit further comprises a third memory, the third memory to store the feature map computed by the batch-norm unit.

7. The IC device of claim 1, further comprising:
one or more memories; and
an embedding dot unit coupled with the one or more memories, the embedding dot unit comprising one or more adders and one or more multipliers, the embedding dot unit to perform a matrix multiplication operation in the neural network.

8. The IC device of claim 7, wherein the one or more memories are of a same type as the first memory or the second memory.

9. The IC device of claim 1, wherein the pooling unit is to perform a max pooling operation or an average pooling operation on the feature map computed by the activator unit.

10. The IC device of claim 1, wherein the activation function is Rectified Linear Unit.

11. An integrated circuit (IC) device, comprising:
an embedder unit comprising one or more look-up tables, the embedder unit to convert one or more input tokens of an input image into a feature map; and
one or more etched mind units, an etched mind unit comprising:
a convolution unit to perform a convolution of a neural network on the feature map, the convolution unit comprising a first memory, the first memory to store a kernel of the convolution,
a batch-norm unit to apply a batch normalization function to a feature map computed by the convolution unit, the batch-norm unit comprising a second memory, the second memory to store one or more parameters of the batch normalization function, and
an activator unit to apply an activation function on a feature map computed by the batch-norm unit, the activator unit comprising a multiplexer, the multiplexer to select a value between an element in the feature map computed by the batch-norm unit and zero; and
a flow control unit to orchestrate the embedder unit and one or more etched mind units based on a timing sequence of the neural network.

12. The IC device of claim 11, wherein the first memory or the second memory is a read-only memory or a dynamic random-access memory.

13. The IC device of claim 11, wherein the etched mind unit further comprises:
one or more memories; and
an embedding dot unit coupled with the one or more memories, the embedding dot unit comprising one or more adders and one or more multipliers, the embedding dot unit to perform a matrix multiplication operation in the neural network.

14. The IC device of claim 13, wherein the one or more memories are of a same type as the first memory or the second memory.

15. The IC device of claim 11, wherein the etched mind unit further comprises a pooling unit, the pooling unit to perform a max pooling operation on the feature map computed by the activator unit.

16. The IC device of claim 11, wherein the activator unit further comprises a third memory, the third memory to store the feature map computed by the batch-norm unit.

17. The IC device of claim 11, wherein the second memory is further to store the feature map computed by the convolution unit.

18. An integrated circuit (IC) device, comprising:
a first processing unit comprising a first memory, a first group of multipliers, and a first group of adders, the first processing unit to perform a sequence of neural network operations in a neural network;
a second processing unit comprising a second memory, a second group of multipliers, and a second group of adders, the second processing unit to perform the sequence of neural network operations using data computed by the first processing unit; and
a third processing unit comprising a third memory, a third group of multipliers, and a third group of adders, the third processing unit to perform the sequence of neural network operations in the neural network using data computed by the second processing unit.

19. The IC device of claim 18, wherein the sequence of neural network operations comprises a convolution, a batch normalization, and an activation function operation.

20. The IC device of claim 18, wherein the first memory, the second memory, or the third memory is a read-only memory.
